(19) United States
(12) Patent Application Publication
(10) Pub. No.: US 2025/0157714 A1
(43) Pub. Date: May 15, 2025

(54) MULTI-TURN COIL STRUCTURE INCLUDING CROSSOVER CONNECTIONS FOR INDUCTIVE ANGULAR-POSITION SENSOR

(71) Applicant: Microchip Technology Incorporated, Chandler, AZ (US)

(72) Inventors: Ganesh Shaga, Warangal (IN); Surendra Akkina, Hyderabad (IN); Sudheer Puttapudi, Hyderabad (IN)

(21) Appl. No.: 18/947,733

(22) Filed: Nov. 14, 2024

(30) Foreign Application Priority Data
Nov. 14, 2023 (IN) 202341077394

(51) Int. Cl. H01F 27/00; G01B 7/30; H01F 5/04; H01F 17/02

(52) U.S. Cl. CPC H01F 27/006; H01F 5/04; H01F 17/02; G01B 7/30

(57) ABSTRACT

An apparatus includes a support structure and a sense coil comprising conductive traces on, or in, multiple layers of the support structure. The sense coil includes a first coil portion, a second coil portion, and first and second crossover connections. The first coil portion has M turns defining one or more in-phase lobes and the second coil portion has N turns defining one or more out-of-phase lobes. The first crossover connection connects an ending portion of an Mth turn of the first coil portion of an in-phase lobe to a starting portion of a first turn of the second coil portion of an out-of-phase lobe. The second crossover connection connects an ending portion of an Nth turn of the second coil portion of the out-of-phase lobe to a starting portion of a first turn of the first coil portion of the in-phase lobe.

### PRIORITY CLAIM

This application claims the benefit of the filing date of Republic of India Provisional Patent Application No. 202341077394, filed Nov. 14, 2023, for “Coil Structure Including Crossover Connection for Inductive Angular-Position Sensor,” the disclosure of which is hereby incorporated herein in its entirety by this reference.

### FIELD

This invention relates generally to inductive angular-position sensing. More specifically, some examples relate to inductive angular-position sensors for measuring the position of a movable target, without limitation. Additionally, devices, systems, and methods are disclosed.

### BACKGROUND

If a coil of wire is placed in a changing magnetic field, a voltage will be induced at ends of coil of wire. In a predictably changing magnetic field, the induced voltage will be predictable (based on factors including the area of the coil affected by the magnetic field and the degree of change of the magnetic field). It is possible to disturb a predictably changing magnetic field and measure a resulting change in the voltage induced in the coil of wire. Further, it is possible to create a sensor that measures movement of a disturber of a predictably changing magnetic field based on a change in a voltage induced in a coil of wire.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1A is a top-down view of a front side of an apparatus comprising an inductive angular-position sensor, according to one or more examples of the disclosure;

FIG. 1B is a top-down view of a reverse side of the apparatus of FIG. 1A;

FIGS. 2A and 2B are top-down, close-up views of a coil structure of the inductive angular-positioning sensor of FIGS. 1A and 1B, where the coil structure includes a first sense coil and a second sense coil, according to one or more examples;

FIG. 3A is a top-down view of a first coil portion of the second sense coil of FIGS. 2A and 2B, according to one or more examples;

FIG. 3B is a top-down view of a second coil portion of the second sense coil of FIGS. 2A and 2B, according to one or more examples;

FIG. 3C is a top-down view of the second sense coil including the first coil portion and the second coil portion (i.e., a combination of the first coil portion of FIG. 3A and the second coil portion of FIG. 3B), according to one or more examples;

FIG. 3D is a close-up view of an inter-lobe region including crossover connections for the second sense coil of FIG. 3D;

FIG. 4A is a first perspective view of a portion of the first and the second sense coils of the coil structure of FIGS. 1A, 1B, 2A, 2B, and 3A-3D, according to one or more examples;

FIG. 4B is a close-up of the crossover connections of the first and the second sense coils in the first perspective view of FIG. 4A;

FIG. 4C is a second perspective view of a portion of the first and the second sense coils of the coil structure of FIGS. 1A, 1B, 2A, 2B, and 3A-3D, according to one or more examples;

FIG. 4D is a close-up of the crossover connections of the first and the second sense coils in the second perspective view of FIG. 4C;

FIG. 5A is a third perspective view of a portion of the first and the second sense coils of the coil structure of FIGS. 1A, 1B, 2A, 2B, 3A-3D, and 4A-4D, according to one or more examples;

FIG. 5B is a close-up of the turn connections of the first and the second sense coils in the third perspective view of FIG. 5A;

FIG. 6 is a schematic diagram of a position sensor circuitry for the apparatus of FIGS. 1A, 1B, 2A, 2B, 3A-3D, 4A-4D, 5A, and 5B, according to one or more examples;

FIG. 7 is a flowchart describing a method of operating an apparatus comprising an inductive angular-position sensor, according to one or more examples;

FIG. 8 is a graph of sense signals produced according to a simulation of operation of the apparatus comprising the inductive angular-position sensor of FIGS. 1A, 1B, 2A, 2B, 3A-3D, 4A-4D, 5A, and 5B, according to one or more examples;

FIG. 9 is a cross-sectional side view of the apparatus comprising the inductive angular-position sensor of FIGS. 1A, 1B, 2A, 2B, 3A-3D, 4A-4D, 5A, and 5B, in one or more examples;

FIG. 10 is a top-down view of an apparatus comprising an inductive angular-position sensor, according to one or more examples of the disclosure;

FIG. 11A is a top-down view of the first sense coil with the other coils removed for illustrative clarity;

FIG. 11B is a close-up view of crossover connections in an inter-lobe region of the first sense coil of the top-down view of FIG. 11A;

FIG. 12 is a close-up view of turn connections of the first coil portion of the first sense coil of the top-down view of FIG. 11A;

FIG. 13 is a top-down view of an apparatus comprising at least one inductive angular-position sensor, according to one or more examples of the disclosure;

FIG. 14A is a close-up, top-down view of a coil structure of the apparatus of FIG. 13;

FIG. 14B is a close-up, first perspective view of the coil structure of FIG. 14A to depict crossover connections of the coil structure;

FIG. 14C is a close-up, second perspective view of the coil structure of FIG. 14A to depict the crossover connections of the coil structure;

FIG. 14D is a further close-up of the second perspective view of the coil structure of FIG. 14C to better depict the crossover connections of the coil structure;

FIG. 15A is a top-down view of an apparatus comprising a coil structure of an inductive angular-position sensor that is known by the inventors of this disclosure;

FIG. 15B is a close-up view of a portion of the coil structure of FIG. 15A to better illustrate crossover points of the coil structure;

FIG. 15C is a top-down view of a first sense coil of the coil structure of FIG. 15A including first and second coil portions with the other coils removed for illustrative clarity;

FIG. 15D is a close-up view of the crossover points that connect forward and reverse paths of the first and the second coils portions associated with two (2) turns of the first sense coil of FIG. 15C; and

FIG. 16 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples of examples in which the present disclosure may be practiced. These examples are described in sufficient detail to enable a person of ordinary skill in the art to practice the present disclosure. However, other examples may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an example of this disclosure to the specified components, steps, features, functions, or the like.

It will be readily understood that the components of the examples as generally described herein and illustrated in the drawing could be arranged and designed in a wide variety of different configurations. Thus, the following description of various examples is not intended to limit the scope of the present disclosure, but is merely representative of various examples. While the various aspects of the examples may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the examples disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

There is demand for position sensors that are light-weight, low cost, reliable, and/or noise immune or resistant. One option is inductive position sensors.

Position sensors, including angular-position sensors, are useful. Some examples of the disclosure relate to a non-contacting planar inductive sensor for measuring the position of a movable target. There are many advantages to planar inductive sensing technology, such as: contactless sensing technology, easily designed on printed circuit board (PCB) with a metallic object (e.g., formed of a metal sheet) as target, suitable for harsh environments, cost effective, resistance to magnetic fields, immune to electromagnetic interference (EMI)/electromagnetic compatibility (EMC).

An inductive angular-position sensor may include an oscillator, one or more oscillator coils (or excitation coils), a first sense coil, a second sense coil, and an integrated circuit (e.g., including processing circuitry). Such an inductive angular-position sensor may determine an angular position of a target relative to the one or more oscillator coils and/or the sense coils.

The oscillator may be configured to generate an excitation signal. The one or more oscillator coils may be excited by the excitation signal. The oscillating signal on the one or more oscillator coils may generate a changing (alternating) magnetic field near and especially within a space encircled by the oscillator coil.

The first sense coil and the second sense coil may each encircle a space in which the one or more oscillator coils are capable of generating magnetic field, e.g., a space within the space encircled by the one or more oscillator coils. The changing magnetic field generated by the one or more oscillator coils may induce a first oscillating voltage at ends of the first sense coil and a second oscillating voltage at ends of the second sense coil. The first oscillating voltage at the ends of the first sense coil may oscillate in response to the oscillation of the excitation signal and may be a first sense signal. The second oscillating voltage at the ends of the second sense signal may oscillate in response to the oscillation of the excitation signal and may be a second sense signal.

The target may be positioned relative to the one or more oscillator coils, the first sense coil, and the second sense coil. For example, the target, or a portion of the target, may be positioned above a portion of the one or more oscillator coils, the first sense coil, and the second sense coil, without limitation. The target may disrupt some of the changing magnetic field that passes through one or more loops of the first sense coil and the second sense coil.

The first sense coil and the second sense coil may be configured such that the location of the target, or the portion of the target, above one or more of the first sense coil and the second sense coil may affect the first sense signal and the second sense signal induced in the first sense coil and the second sense coil respectively. For example, the target may disrupt magnetic coupling between the excitation coil and the sense coils. Such disruption may affect a magnitude of the sense signals in the sense coils. For example, in response to the target, or a the portion of the target, being over a loop in the first sense coil, the amplitude of the first sense signal may be less than the amplitude of the first sense signal when the target is not over the loop in the first sense coil.

Further, the target may be configured to rotate (e.g., around an axis, without limitation) such that a portion of the target may pass over one or more loops of one or more of the one or more excitation coils, the first sense coil and the second sense coil. As the target rotates, each of the first sense signal of the first sense coil and the second sense signal of the second sense coil may be amplitude modulated in response to the rotation of the target and in response to the portion of the target passing over the loops.

In various examples, the integrated circuit may be configured to generate an output signal responsive to the first sense signal and the second sense signal. The output signal may be a fraction of a rail voltage based on the first sense signal and the second sense signal. The output signal may be related to an angular position of the target, or the position of the portion of the target, and successive samples of the output signal may be related to a direction of movement of the target. Thus, the inductive angular-position sensor may be configured to generate an output signal indicative of an angular position of a target.

In various examples, the integrated circuit may be configured to generate a first output signal based on the first sense signal and a second output signal based on the second sense signal. The first output signal may be the first sense signal demodulated; the second output signal may be the second sense signal demodulated. Together, the two output signals may be related to an angular position of the target and subsequent samples of the first and second output signals may be indicative of rotation of the target.

In various examples, the integrated circuit may be configured to generate a single output signal based on the first sense signal and the second sense signal. Some examples include sense coils and/or targets that cause an integrated circuit to generate a constant-slope output signal in response to rotation of the target, relative to the first sense coil and the second sense coil. The constant-slope output signal may be an output signal with a known correlation between an amplitude of the output signal and the angular position of the target.

Various examples of the present disclosure may include elements of inductive angular-position sensors (including, e.g., sense coils and targets) which may allow such inductive angular-position sensors to provide a more accurate correlation between output signals and the angular position of the target relative to the sense coils. In other words, various examples of the present disclosure may include elements for inductive angular-position sensors that may cause the inductive angular-position sensors to be more accurate than other inductive angular-position sensors. Additionally or alternatively, various examples may include inductive angular-position sensors that are more accurate than other inductive angular-position sensors.

As a non-limiting example, various examples may include targets and/or sense coils having a shapes that may cause sense signals from the respective sense coils to exhibit desirable waveform shapes, e.g., waveform shapes that are close-to-ideal waveform shapes. The shapes of targets and/or path portions of the sense coils may be related to how the sense signals generated therein are amplitude modulated as a target disrupts magnetic field between the excitation coil and the sense coils. As a non-limiting example, as a target rotates above sense coils and disrupts the magnetic field between the excitation coil and the sense coils, the shape of the target and/or the sense coils may determine the shape of an amplitude-modulation envelope exhibited by the sense signals. As a non-limiting example, an amplitude-modulation envelope of sense signals of sense coils of various examples may be close to a sinusoidal shape. A sinusoidally-shaped amplitude-modulation envelope may be well-suited for translation into an angular position (e.g., through a trigonometric function, such as an arctangent function).

Various examples of the present disclosure may include elements of inductive angular-position sensors (including, e.g., sense coils) which allow for a relatively larger airgap between the target and the sense coils with a lower form factor of substrate space. This would allow assembly of the sensor to be relatively easy, even considering the tolerances associated with manufacturing.

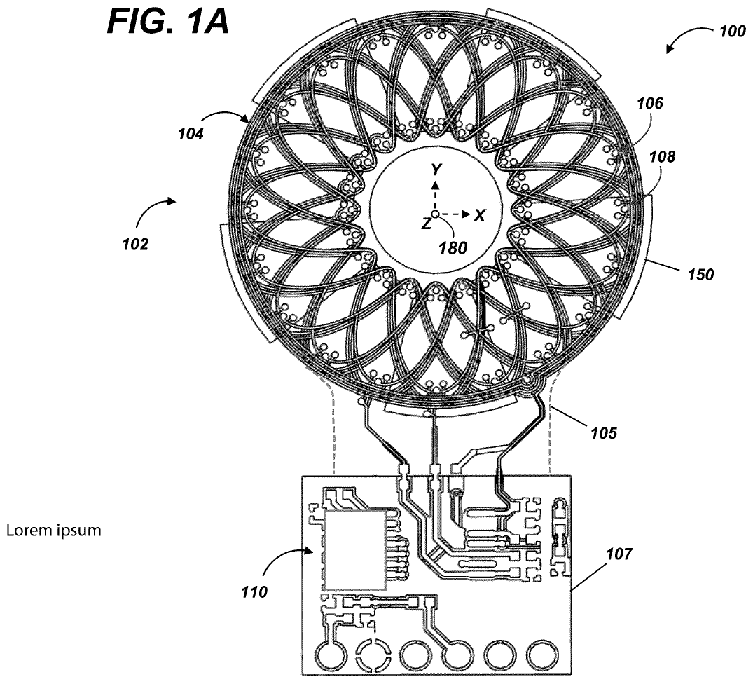

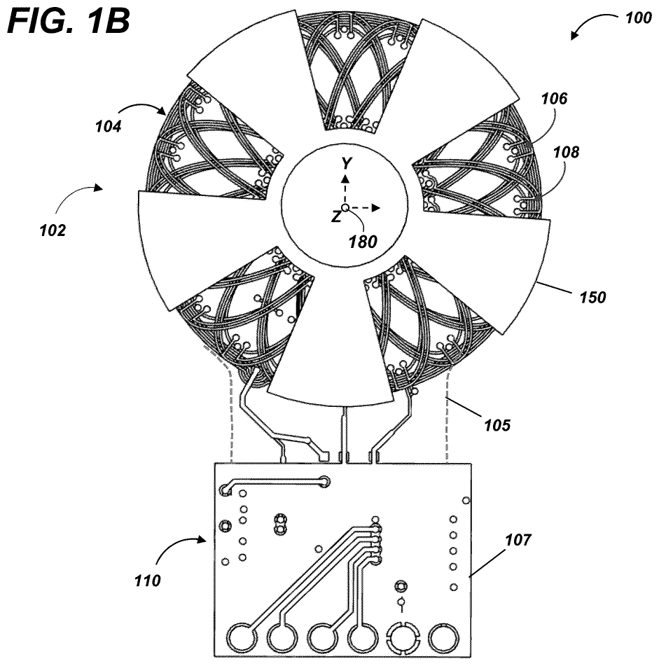

FIG. 1A is a top-down view of a front side of an apparatus 100 comprising an inductive angular-position sensor, according to one or more examples of the disclosure. FIG. 1B is a top-down view of a reverse side of apparatus 100 of FIG. 1A. The inductive angular-position sensor of FIGS. 1A and 1B is adapted for inductive sensing of an angular position of a target 150 that is rotatable about an axis 180 (e.g., a central axis of rotation). In FIGS. 1A and 1B, axis 180 is shown as the Z-axis in a three-dimensional coordinate axis system (X-Y-Z).

Apparatus 100 includes a coil structure 102 for inductive angular-position sensing. Coil structure 102 includes one or more oscillator coils 104, a first sense coil 106, and a second sense coil 108. One or more oscillator coils 104 may be referred to as one or more primary coils, and first and second sense coils 106 and 108 may be referred to as secondary coils. In one or more examples, one or more oscillator coils 104 and first and second sense coils 106 and 108 are substantially planar coils.

In one or more examples, coil structure 102 may be at least partially formed by conductive traces on and/or in one or more layers (e.g., multiple layers or planes) of a support structure 105. In one or more examples, support structure 105 may be or include a substrate, such as a printed circuit board (PCB). When multiple planes are used for coil arrangements, the multiple planes may be parallel planes at different heights of the substrate. For example, a respective one of the multiple planes may be associated with a different one of multiple layers of a PCB.

Target 150 has a target body which is generally planar (i.e., in-plane with the page) and circular. In one or more examples, target 150 includes multiple fins that are evenly radially spaced around axis 180 (e.g., defining a circular fan shape). In the specific, non-limiting example, the number of fins of the target is five (5). In one or more examples, the (e.g., five) multiple fins of target 150 are equally, radially spaced about axis 180, at 72° intervals. Note that the symbol “°” is used herein to represent “degree” and “degrees,” which are a measurement of a plane angle in which a full rotation is 360°.

The target body of target 150 may be made of a conductive material, such as a non-magnetic conductive metal or metal alloy, without limitation. In one or more examples, the non-magnetic conductive metal or metal alloy may be or include copper or aluminum. In one or more other examples, the target body of target 150 may be made of a magnetic conductive metal or metal alloy, such as carbon steel or ferritic stainless steel, without limitation. Here, an oscillator may generate an excitation signal within a certain range of frequencies (e.g., 1-6 MHZ, without limitation) that the magnetic domains of the magnetic conductive metals or metal alloys will not react to.

When apparatus 100 is in operational use, target 150 rotates around axis 180 (e.g., target 150 may be connected to a through-shaft, which may extend through support structure 105). Target 150 may disrupt magnetic coupling between one or more oscillator coils 104 and first and second sense coils 106 and 108, such that sense signals induced in first and second sense coils 106 and 108 are indicative of an angular position of target 150 as it rotates around axis 180. The degree to which target 150 disrupts magnetic coupling between one or more oscillator coils 104 and first and second sense coils 106 and 108 may vary at least partially in response to changes in the angular position of target 150.

For angular-position sensing of target 150, the inductive angular-position sensor may include a processing circuitry 110. In one or more examples, processing circuitry 110 of the inductive angular-position sensor may be or include a sensor IC. Processing circuitry 110 (e.g., the sensor IC) is disposed on a substrate 107, such as a PCB, which may or may not be an extension of support structure 107. In an example operation, processing circuitry 110 generates a high-frequency signal to excite one or more oscillator coils 104 for producing an alternating magnetic field. The magnetic field couples onto first and second sense coils 106 and 108 for generating a voltage. As target 150 disturbs the generated magnetic field, first and second sense coils 106 and 108 will receive different voltages versus target position. When there is no target, voltage induced in the coils will be zero. When target 150 is present and is rotating, it creates modulated sine and cosine waveforms given as feedback signals to processing circuitry 110 (e.g., the IC). Internal to the IC, the signals are de-modulated, and position information may be calculated, for example, by taking an arctan2 function of the ratio of the two sense signals, which may be sine and cosine signals. The sine and cosine signals may be close to ideal sine and cosine waveforms, resulting in relatively high accuracy and resolution.

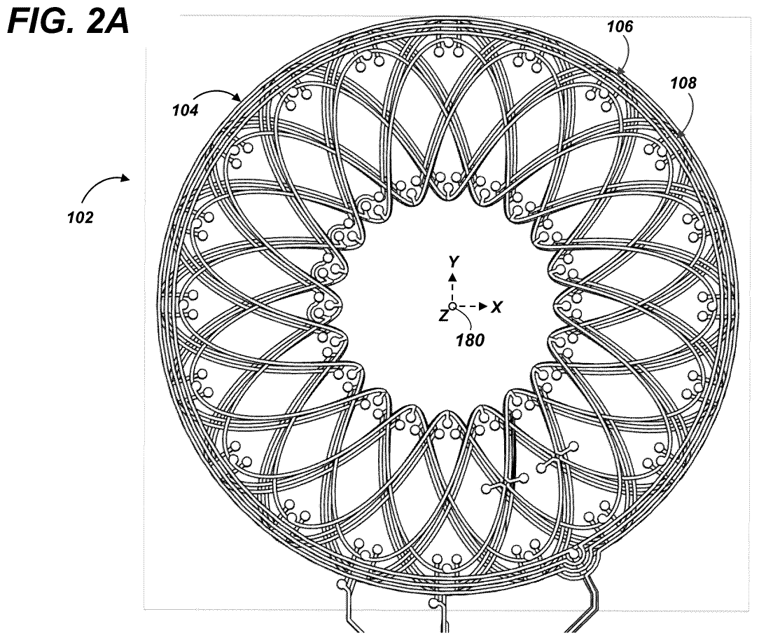

FIGS. 2A and 2B are close-up, top-down views of coil structure 102 of the apparatus of FIGS. 1A and 1B. One or more oscillator coils 104 define an annular-shaped path arranged around axis 180 for electrical current to flow. Respective ones of first sense coil 106 and second sense coil 108 define a conductive (e.g., continuous) path for electrical current to flow between a first location and a second location. In FIG. 2B, first sense coil 106 is provided without light dotted circle indications and second sense coil 108 is provided with light dotted circle indications to better distinguish the coils from each other. In general, respective ones of first sense coil 106 and second sense coil 108 are arranged within an annulus centered around axis 180.

First sense coil 106 includes a first coil portion and a second coil portion. The first coil portion of first sense coil 106 defines a first path (e.g., a forward path) for electrical current to flow in a first direction (e.g., a clockwise direction) around axis 180. The first coil portion of first sense coil 106 has M turns around axis 180 defining one or more in-phase lobes arranged around axis 180. More specifically in FIG. 2B, the first coil portion of first sense coil 106 having M turns defines a substantially-sinusoidal-wave-shaped path including multiple positive or in-phase lobes 202a, 204a, 206a, 208a, and 210a arranged around axis 180. Respective ones of in-phase lobes 202a, 204a, 206a, 208a, and 210a have peak and valley portions extending between respective outer and inner circles of the annulus. In one or more examples, M is an integer number greater than or equal to two (2).

The second coil portion of first sense coil 106 defines a second path (e.g., a reverse path) for the electrical current to flow in a second direction (e.g., a counter-clockwise direction) around axis 180. The second coil portion of first sense coil 106 has N turns around axis 180 defining one or more out-of-phase lobes arranged around axis 180. More specifically in FIG. 2B, the second coil portion of first sense coil 106 having N turns defines a substantially-sinusoidal-wave-shaped path including multiple negative or out-of-phase lobes 202b, 204b, 206b, 208b, and 210b arranged around axis 180. Respective ones of out-of-phase lobes 202b, 204b, 206b, 208b, and 210b have peak and valley portions extending between the respective outer and inner circles of the annulus. In one or more examples, N is an integer number greater than or equal to two (2). In the specific, non-limiting example shown, M=N=3.

In one or more examples, the number of L lobes of respective ones of the first and the second coil portions of first sense coil 106 is five (5), and therefore the total number of lobes of first sense coil 106 is ten (10) lobes. Respective lobes of the first coil portion of first sense coil 106 are arranged α degrees (mechanically) out of phase with respective lobes of the second coil portion of first sense coil 106. In one or more examples, α=360°/(2×L). In a specific, non-limiting example, α=360°/(2×5)=36°.

Crossover connections 250 are provided in an inter-lobe region 260 of first sense coil 106 to electrically connect the forward and the reverse paths of the first and the second coil portions of first sense coil 106. Inter-lobe region 260 is a region at which an in-phase lobe (e.g., in-phase lobe 206a) of the first coil portion meets with an out-of-phase lobe (e.g., out-of-phase lobe 204b) of the second coil portion.

Second sense coil 108 also includes a first coil portion and a second coil portion. The first coil portion of second sense coil 108 defines a third path (e.g., a forward path) for electrical current to flow in the first direction (e.g., the clockwise direction) around axis 180. The first coil portion of second sense coil 108 has M turns around axis 180 defining one or more in-phase lobes arranged around axis 180. More specifically, the first coil portion of second sense coil 108 having M turns defines a substantially-sinusoidal-wave-shaped path including multiple positive or in-phase lobes 215a, 217a, 219a, 221a, and 223a arranged around axis 180. Respective ones of in-phase lobes 215a, 217a, 219a, 221a, and 223a have peak and valley portions extending between the respective outer and inner circles of the annulus. In one or more examples, M is the integer number greater than or equal to two (2).

The second coil portion of second sense coil 108 defines a fourth path (e.g., a reverse path) for the electrical current to flow in the second direction (e.g., the counter-clockwise direction) around axis 180. The second coil portion of second sense coil 108 has N turns around the axis defining one or more out-of-phase lobes arranged around axis 180. More specifically, the second coil portion of second sense coil 108 having N turns defines a substantially-sinusoidal-wave-shaped path including multiple negative or out-of-phase lobes 215b, 217b, 219b, 221b, and 223b arranged around axis 180. Respective ones of out-of-phase lobes 215b, 217b, 219b, 221b, and 223b have peak and valley portions extending between the respective outer and inner circles of the annulus. In one or more examples, N is the integer number greater than or equal to two (2). Again, in the specific, non-limiting example shown, M=N=3.

In one or more examples, the number of L lobes of respective ones of the first and the second coil portions of second sense coil 108 is five (5), and therefore the total number of lobes of second sense coil 108 is ten (10) lobes. Respective lobes of the first coil portion of second sense coil 108 are arranged α degrees (mechanically) out of phase with respective lobes of the second coil portion of second sense coil 108. In one or more examples, α=360°/(2×L). In a specific, non-limiting example, where each coil portion has five (5) lobes, α=360°/(2×5)=36°.

Crossover connections 270 are provided in an inter-lobe region 280 of second sense coil 108 to electrically connect the forward and the reverse paths of the first and the second coil portions of second sense coil 108. Inter-lobe region 280 is a region at which an in-phase lobe (e.g., in-phase lobe 217a) of the first coil portion meets with an out-of-phase lobe (e.g., out-of-phase lobe 217b) of the portion coil portion.

In one or more examples, respective lobes of first sense coil 106 are arranged Θ degrees out of phase with respective lobes of second sense coil 108 so as to produce sinusoidal wave signals that are 90° out of phase with each other. In one or more examples, Θ=360°/(2*L). In a specific, non-limiting example, where each sense coil has ten (10) lobes, Θ=360°/(2*10)=18°. Accordingly, in one or more examples, the apparatus including the inductive angular-position sensor is a five (5) pole pair sensor that provides a 72° measurement range with respect to the target.

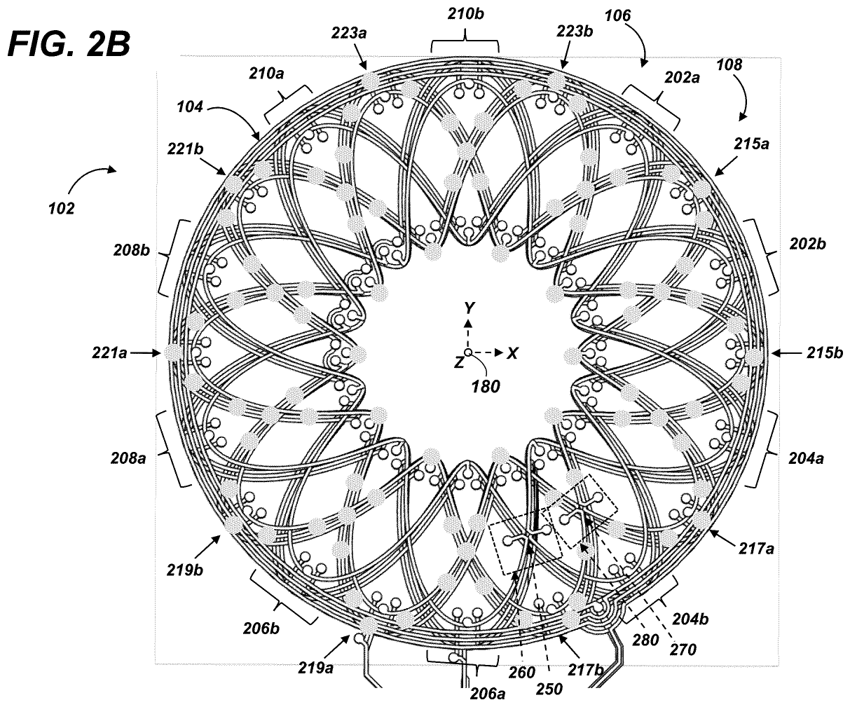

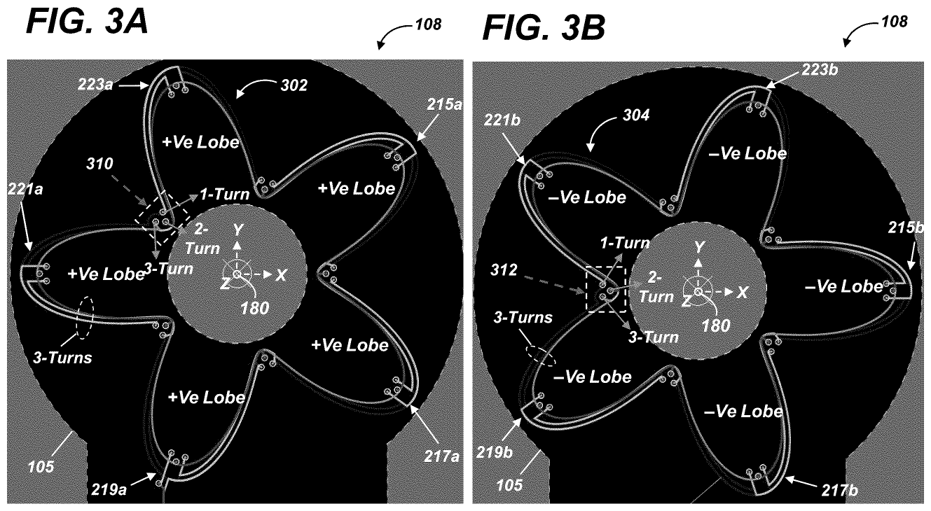

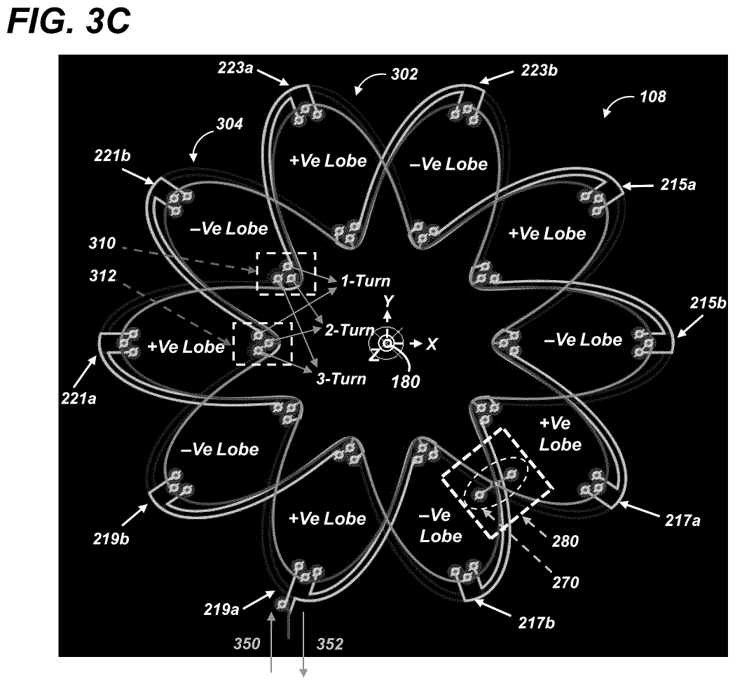

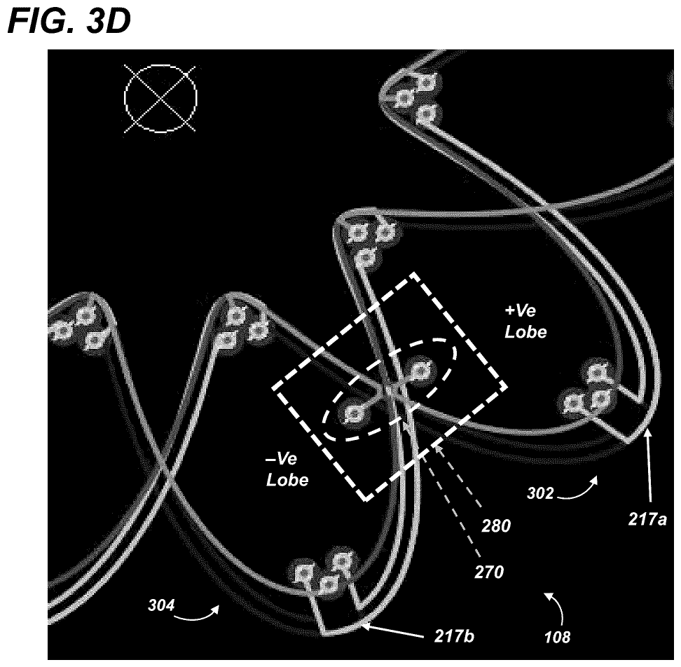

FIG. 3A is a top-down view of a first coil portion 302 of second sense coil 108 of FIGS. 2A and 2B with the other coils removed for illustrative clarity. First coil portion 302 of second sense coil 108 in FIG. 3A having the M turns (e.g., where M=3) better illustrates the substantially-sinusoidal-wave-shaped path including multiple positive or in-phase lobes 215a, 217a, 219a, 221a, and 223a arranged around axis 180. As previously discussed, first coil portion 302 of second sense coil 108 defines a first path (e.g., a forward path) for electrical current to flow in a first direction (e.g., a clockwise direction) around axis 180.

In FIG. 3A, first coil portion 302 of second sense coil 108 is shown to further include a turn region 310 having M turn connections. In one or more examples, turn region 310 is located in a valley between two of the in-phase lobes of first coil portion 302 (e.g., between in-phase lobes 221a and 223a). Respective ones of the M turn connections (e.g., three (3) turn connections) are to connect a respective turn of first coil portion 302 to a respective next turn of first coil portion 302 through a respective one of M conductive vias (e.g., three (3) conductive vias).

FIG. 3B is a top-down view of a second coil portion 304 of second sense coil 108 of FIGS. 2A and 2B with the other coils removed for illustrative clarity. Second coil portion 304 of second sense coil 108 in FIG. 3B having the N turns (e.g., where N=3) better illustrates the substantially-sinusoidal-wave-shaped path including multiple negative or out-of-phase lobes 215b, 217b, 219b, 221b, and 223b arranged around axis 180. As previously discussed, second coil portion 304 of second sense coil 108 defines a second path (e.g., a reverse path) for electrical current to flow in a second direction (e.g., a counter-clockwise direction) around axis 180. In FIG. 3B, second coil portion 304 of second sense coil 108 is shown to further include a turn region 312 having N turn connections. In one or more examples, turn region 312 is located in a valley between two of the out-of-phase lobes of second coil portion 304 (e.g., between out-of-phase lobes 219b and 221b). Respective ones of the N turn connections (e.g., three (3) turn connections) are to connect a respective turn of second coil portion 304 to a respective next turn of second coil portion 304 through a respective one of N conductive vias (e.g., three (3) conductive vias).

FIG. 3C is a top-down view of second sense coil 108 including first coil portion 302 (FIG. 3A) and second coil portion 304 (FIG. 3B) with the other coils removed for illustrative clarity. FIG. 3C including both (combined) first and second coil portions 302 and 304 of second sense coil 108 better illustrate the substantially-sinusoidal-wave-shaped paths of second sense coil 108 including the multiple alternating in-phase and out-of-phase lobes 215a, 215b, 217a, 217b, 219a, 219b, 221a, 221b, 223a, and 223b arranged around axis 180. Also shown in FIG. 3C is inter-lobe region 280 including crossover connections 270 to electrically connect the forward and the reverse paths of first and second coil portions 302 and 304 of second sense coil 108. A close-up view of inter-lobe region 280 including crossover connections 270 is also shown in FIG. 3D. Inter-lobe region 280 is a region at which in-phase lobe 217a of first coil portion 302 of second sense coil 108 meets with (adjacent) out-of-phase lobe 217b of second coil portion 304 of second sense coil 108.

In FIG. 3C, turn region 310 having the M turn connections and turn region 312 having the N turn connections are also indicated. Also in FIG. 3C, an entry point 350 (e.g., a first location) to the first path (e.g., the forward path) of first coil portion 302 of second sense coil 108 and an exit point 352 (e.g., a second location) from the second path (e.g., the reverse path) of second coil portion 304 of second sense coil 108 are indicated in the figure. Note that, in FIGS. 3A-3D, any black or dark background shading may be removed from the figures.

An example arrangement of first and second coil portions 302 and 304 of second sense coil 108 has been described in relation to FIGS. 3A-3D. Note that the arrangement of the first and the second coil portions of the first sense coil of FIGS. 1A, 1B, 2A, and 2B may be substantially the same as the arrangement of first and second coil portions 302 and 304 of second sense coil 108 of FIGS. 3A-3D.

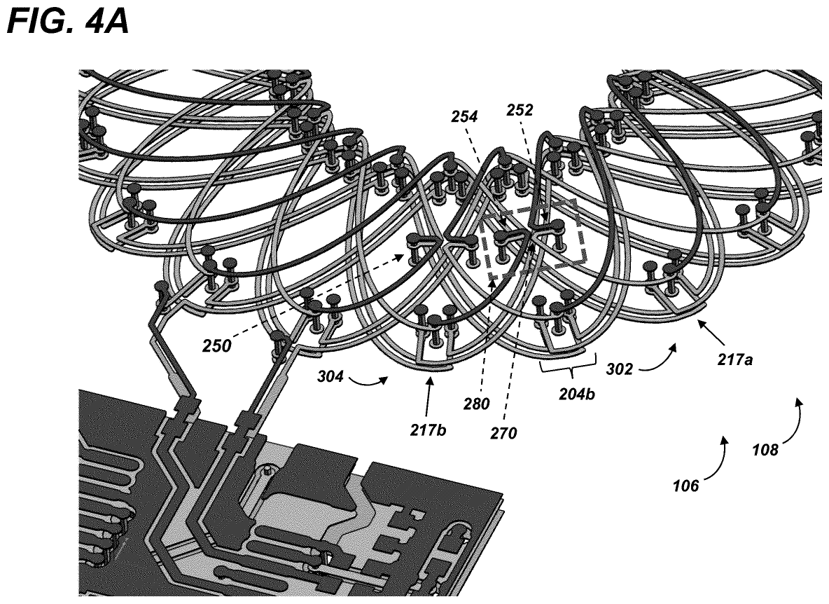

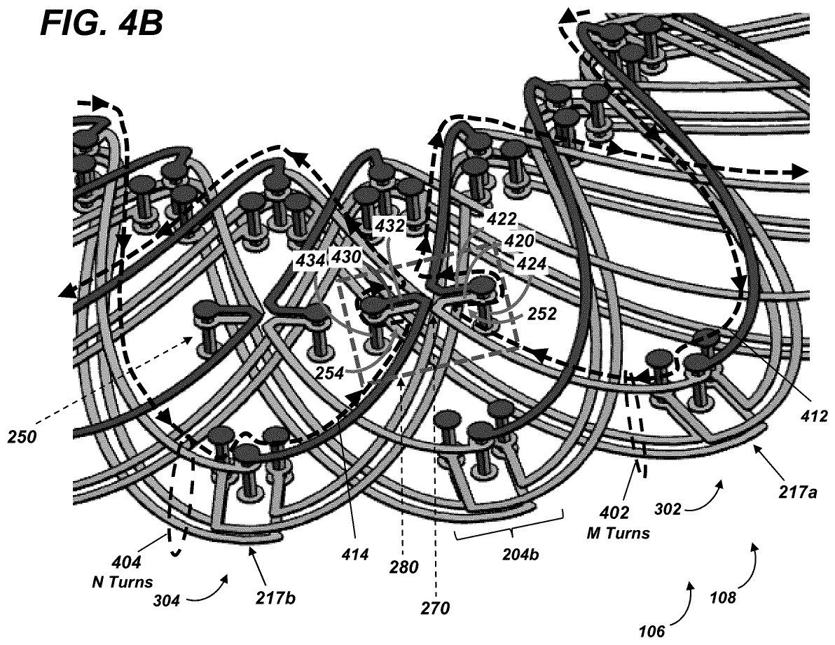

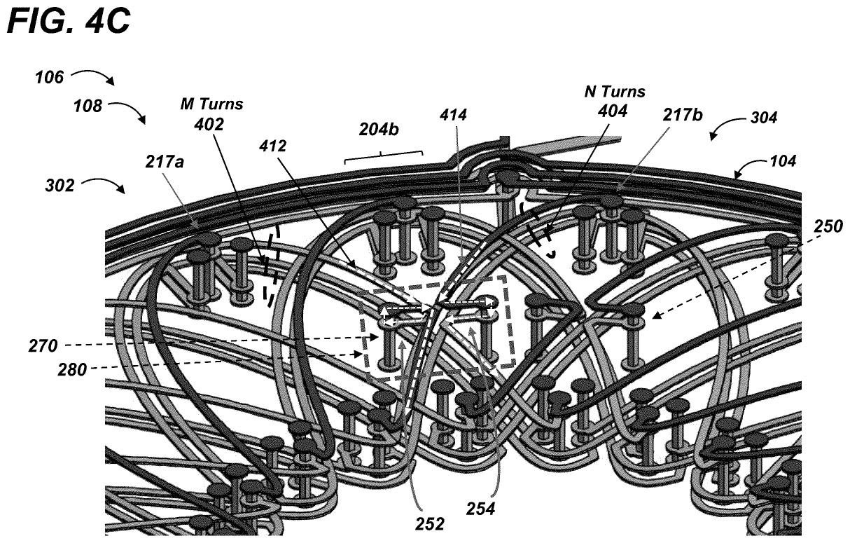

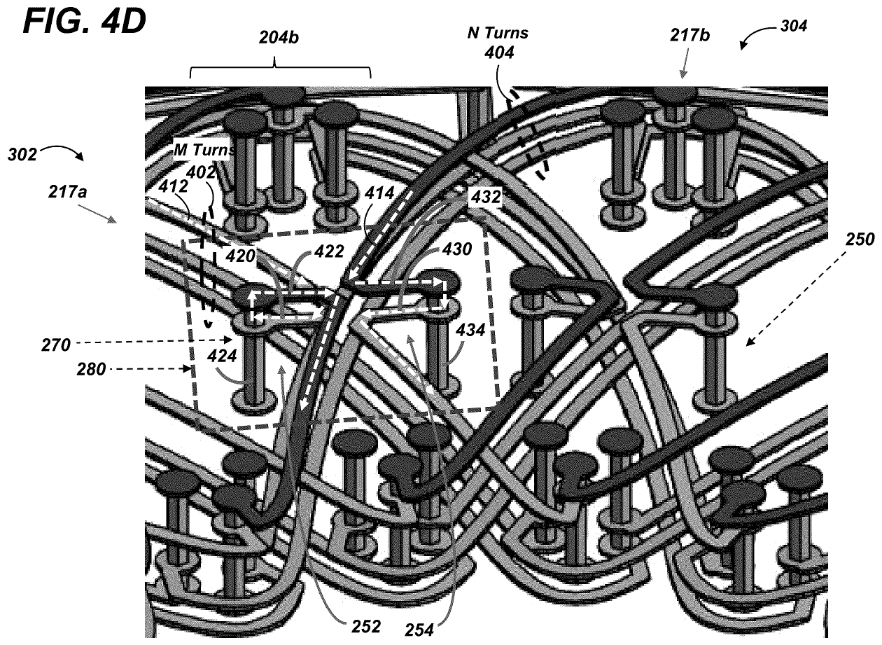

FIG. 4A is a first perspective view of a portion of the first and the second sense coils of the coil structure of FIGS. 1A, 1B, 2A, 2B, and 3A-3D, according to one or more examples. FIG. 4B is a close-up of the crossover connections of the first and the second sense coils in the first perspective view of FIG. 4A. FIG. 4C is a second perspective view of a portion of the first and the second sense coils of the coil structure of FIGS. 1A, 1B, 2A, 2B, and 3A-3D, according to one or more examples. FIG. 4D is a close-up of the crossover connections of the first and the second sense coils in the second perspective view of FIG. 4C.

In FIGS. 4B-4D, first coil portion 302 is indicated to include a number of M turns 402 (e.g., where M=3), and second coil portion 304 is indicated to include a number of N turns 404 (e.g., where N=3). Also in FIGS. 4B-4D, a portion of a first path 412 (e.g., the forward path) of first coil portion 302 is indicated by a dashed arrowed line, and a portion of a second path 414 (e.g., the reverse path) of second coil portion 304 is indicated by another dashed arrowed line.

In FIGS. 4A-4D, crossover connections 270 of inter-lobe region 280 of second sense coil 108 are indicated to include a first crossover connection 252 and a second crossover connection 254 (e.g., a single pair of crossover connections). In general, first and second crossover connections 252 and 254 in inter-lobe region 280 are to electrically connect the forward and the reverse paths of first and second coil portions 302 and 304 of second sense coil 108.

First crossover connection 252 is to connect an ending portion of an Mth turn of first coil portion 302 of in-phase lobe 217a to a starting portion of a first turn of second coil portion 304 of out-of-phase lobe 217b. In one or more examples, the number of M turns 402 of first coil portion 302 is without any other crossover connection to second coil portion 304 except for first crossover connection 252 (e.g., the number of M turns 402 defines a substantially continuous conductive path without any other crossover other than first crossover connection 252).

In one or more examples of FIGS. 4B and 4D, first crossover connection 252 includes a first lateral portion 420, a second lateral portion 422, and a first conductive via 424. First lateral portion 420 is at the ending portion on the Mth turn of first coil portion 302 of in-phase lobe 217a. First lateral portion 420 extends laterally from in-phase lobe 217a in a first lateral direction to connect to first conductive via 424. Second lateral portion 422 is at the starting portion on the first turn of second coil portion 304 of out-of-phase lobe 217b. Second lateral portion 422 extends laterally from out-of-phase lobe 217b in the first lateral direction to connect to first conductive via 424. In one or more examples, first and second lateral portions 420 and 422 connected to first conductive via 424 define a first bridge under which, or over which, N−1 turns of second coil portion 304 are disposed.

Second crossover connection 254 is to connect an ending portion of an Nth turn of second coil portion 304 of out-of-phase lobe 217b to a starting portion of a first turn of first coil portion 302 of in-phase lobe 217a. In one or more examples, the number of N turns 404 of second coil portion 304 is without any other crossover connection to first coil portion 302 except for second crossover connection 254 (e.g., the number of N turns 404 defines a substantially continuous conductive path without any other crossover other than second crossover connection 254).

In one or more examples of FIGS. 4B and 4D, second crossover connection 254 includes a third lateral portion 430, a fourth lateral portion 432, and a second conductive via 434. Third lateral portion 430 is at the ending portion on the Nth turn of second coil portion 304 of out-of-phase lobe 217b. Third lateral portion 430 extends laterally from out-of-phase lobe 217b in a second lateral direction (e.g., opposite the first lateral direction) to connect to second conductive via 434. Fourth lateral portion 432 is at the starting portion on the first turn of first coil portion 302 of in-phase lobe 217a. Fourth lateral portion 432 extends laterally from in-phase lobe 217a in the second lateral direction to connect to second conductive via 434. In one or more examples, third and fourth lateral portions 430 and 432 connected to second conductive via 434 define a second bridge under which, or over which, M−1 turns of first coil portion 302 are disposed.

Note that, in one or more examples, the arrangement of the crossover connections 250 (e.g., first and second crossover connections thereof) of the first sense coil in FIGS. 2B and 4A-4D is substantially the same as the arrangement of crossover connections 270 (e.g., first and second crossover connections 252 and 254 thereof) of second sense coil 108 in FIGS. 3A-3D.

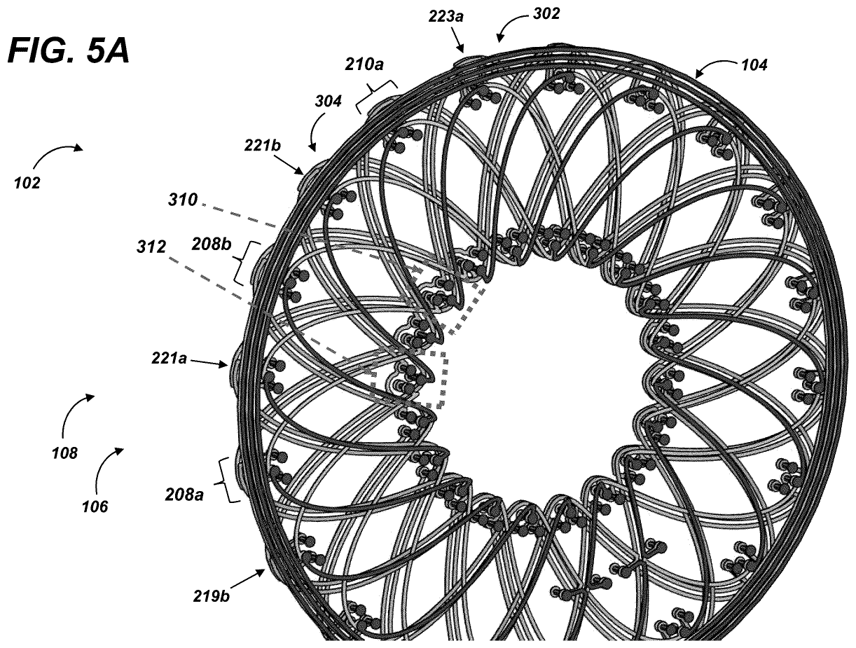

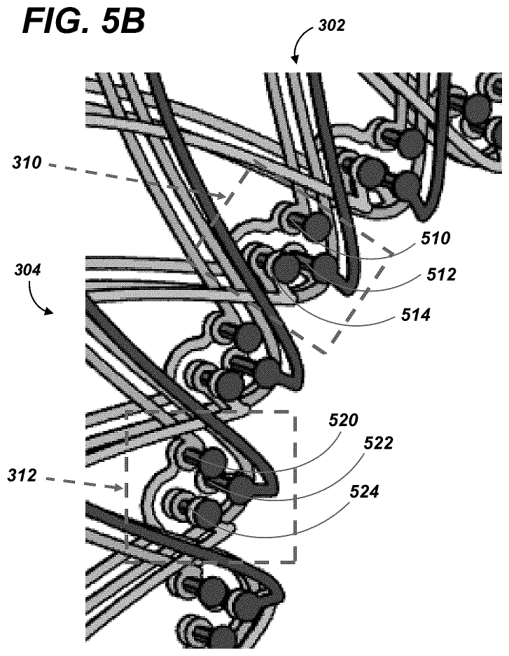

FIG. 5A is a third perspective view of a portion of the first and the second sense coils of the coil structure of FIGS. 1A, 1B, 2A, 2B, 3A-3D, and 4A-4D, according to one or more examples. FIG. 5B is a close-up of the turn connections of the first and the second sense coils in the third perspective view of FIG. 5A.

As shown in FIGS. 5A and 5B (and as similarly previously shown and described in relation to FIGS. 3A-3C), first coil portion 302 of second sense coil 108 includes turn region 310 having the M turn connections (e.g., M turn connections 510, 512, and 514 in FIG. 5B). In one or more examples, turn region 310 is located in a valley between two of the in-phase lobes of first coil portion 302 (e.g., between in-phase lobes 221a and 223a). Respective ones of M turn connections 510, 512, and 514 (FIG. 5B) are to connect a respective turn of first coil portion 302 to a respective next turn of first coil portion 302 through a respective one of M conductive vias. In addition, second coil portion 304 of second sense coil 108 includes turn region 312 having the N turn connections (e.g., N turn connections 520, 522, and 524 in FIG. 5B). Turn region 312 is located in a valley between two of the out-of-phase lobes of second coil portion 304 (e.g., between out-of-phase lobes 219b and 221b). Respective ones of N turn connections 520, 522, and 524 (FIG. 5B) are to connect a respective turn of second coil portion 304 to a respective next turn of second coil portion 304 through a respective one of N conductive vias.

An example arrangement of turn connections of the first and the second coil portions of the second sense coil has been described in relation to FIGS. 3A-3C, 5A, and 5B. Note that the arrangement of turn connections of the first and the second coil portions of the first sense coil may be substantially the same as the arrangement of turn connections of the first and the second coil portions of the second sense coil of FIGS. 3A-3C, 5A, and 5B.

Accordingly, in one or more examples, respective ones of the first sense coil 106 and second sense coil 108 are balanced with equal areas for in-phase lobes and out-of-phase lobes. For each sense coil, respective ones of the in-phase lobes and out-of-phase lobes are routed for three (3) turns and connected together using the above-described crossover connections to create a balanced structure.

In one or more alternative examples of apparatus 100 of FIGS. 1A, 1B, 2A, 2B, 3A-3D, 4A-4D, 5A, and 5B, the first coil portion may be associated with the counter-clockwise path and the second coil portion may be associated with the clockwise path, and/or the in-phase lobes of the first coil portion may include the out-of-phase lobes and the second coil portion may include the in-phase lobes.

In one or more examples, the coil structure is provided on and/or in multiple layers of the support structure (e.g., a PCB). In one or more specific examples, the coil structure may be provided on and/or in first, second, third, and fourth layers of the support structure. In one or more examples (e.g., as illustrated in FIGS. 3A-3D and 4A-4D), the Mth turn of first coil portion 302 (e.g., and other turns thereof) alternates between the first and the second layers of the support structure, at respective peak and valley portions of the multiple in-phase lobes, through respective conductive vias. In addition, the first turn of second coil portion 304 (e.g., and other turns thereof) alternates between the first and the second layers of the support structure, at respective peak and valley portion of the multiple out-of-phase lobes, through respective conductive vias. Furthermore, the Nth turn of second coil portion 304 (e.g., and other turns thereof) alternates between the first and the second layers of the support structure, at respective peak and valley portions of the multiple out-of-phase lobes, through respective conductive vias. Also further, the first turn of first coil portion 302 (e.g., and other turns thereof) alternates between the first and the second layers of the support structure, at respective peak and valley portions of the multiple in-phase lobes, through respective conductive vias. In one or more examples, one or more oscillator coils may be provided in the third and the fourth layers.

Given the above-described arrangement, in one or more examples, the first crossover connection (e.g., first crossover connection 252) is such that the ending portion on the Mth turn of first coil portion 302 on the in-phase lobe on the second layer connects, through a first conductive via (e.g., first conductive via 424), to the starting portion on the first turn of second coil portion 304 on the out-of-phase lobe on the first layer. Also in one or more examples, the second crossover connection (e.g., second crossover connection 254) is such that the ending portion on the Nth turn of second coil portion 304 on the out-of-phase lobe on the first layer connects, through a second conductive via (e.g., second conductive via 434), to the starting portion on the first turn of first coil portion 302 on the in-phase lobe on the second layer.

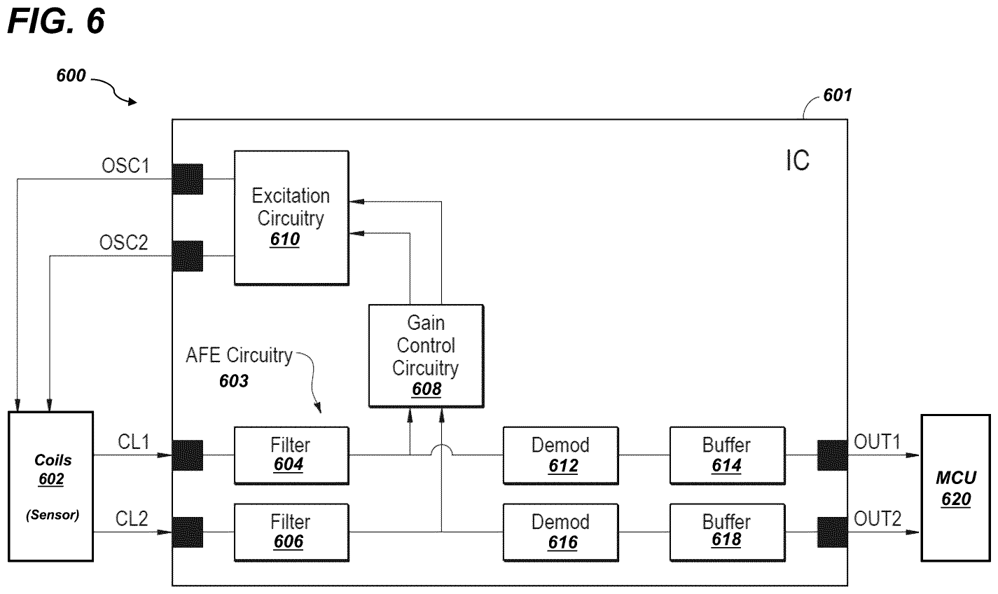

FIG. 6 is a schematic diagram of a position sensor circuitry 600 for apparatus 100 of FIGS. 1A and 1B, according to one or more examples. Position sensor circuitry 600 of FIG. 6 may be processing circuitry 110 of FIGS. 1A and 1B. In one or more examples, position sensor circuitry 600 may be contained (in total or in part) in an integrated circuit (IC) 601. In FIG. 6, the one or more oscillator coils, the first sense coil, and the second sense coil are represented by coils 602 in the figure.

In one or more examples, position sensor circuitry 600 includes an excitation circuitry 610, an analog front-end (AFE) circuitry 603, and a gain control circuitry 608. AFE circuitry 603 may also include, for a modulated first sense signal from the first sense coil (at input CL1), a filter 604 (e.g., an EMI filter), a demodulator 612, and a buffer 614. AFE circuitry 603 may also include, for a modulated second sense signal from the second sense coil (at input CL2), a filter 606 (e.g., an EMI filter), a demodulator 616, and a buffer 618. First and second position signals (e.g., indicating a position of the target) may be provided at outputs OUT1 and OUT2 of position sensor circuitry 600.

In general, the first and second position signals are determined at least partially based on the modulated first and second sense signals from the first and second sense coils (e.g., CL1, CL2), respectively. More specifically, excitation circuitry 610 generates one or more excitation signals in the one or more first oscillator coils (e.g., at OSC1, OSC2) to produce a varying magnetic field for inducing the first and second sense signals in the first and second sense coils, respectively. The first and second sense signals may be first and second sinusoidal signals, respectively, 90° out of phase with each other, in one or more examples (e.g., cosine signals and sine signals). The varying magnetic field may be disturbed in accordance with an angular position of the target for modulating the first and second sense signals in the first and second sense coils. The modulated first and second sense signals are received from the first and second sense coils at inputs (e.g., CL1, CL2). AFE circuitry 603 receives and processes these signals. In particular, the modulated first sense signal (at CL1) is filtered through filter 604, demodulated by demodulator 612 to produce the first position signal, and sent to the output OUT1 through buffer 614. The modulated second sense signal (at CL2) is filtered through filter 606, demodulated by demodulator 616 to produce the second position signal, and sent to the output OUT2 through buffer 618.

In one or more examples, when position sensor circuitry 600 includes a processor (e.g., a central processing unit (CPU)), position sensor circuitry 600 may calculate the angular position of the target at least partially based on the first and second position signals (e.g., based on the arctan2 function provided above, without limitation). In one or more other examples, a microcontroller unit (MCU) 620 or an electronic control unit (ECU) may receive the first and second position signals at the outputs OUT1 and OUT 2, respectively, and calculate the angular position of the target at least partially based on the first and second position signals (e.g., based on the arctan2 function provided above, without limitation).

In one or more examples, the one or more oscillator coils include a first oscillator coil and a second oscillator coil. Excitation circuitry 610 generates a first excitation signal in the first oscillator coil and a second excitation signal in the second oscillator coil. In one or more examples, the second excitation signal is substantially 180° out of phase with the first excitation signal. The first and the second oscillator coils are to produce a varying magnetic field for inducing first and second sense signals in the first and second sense coils, respectively.

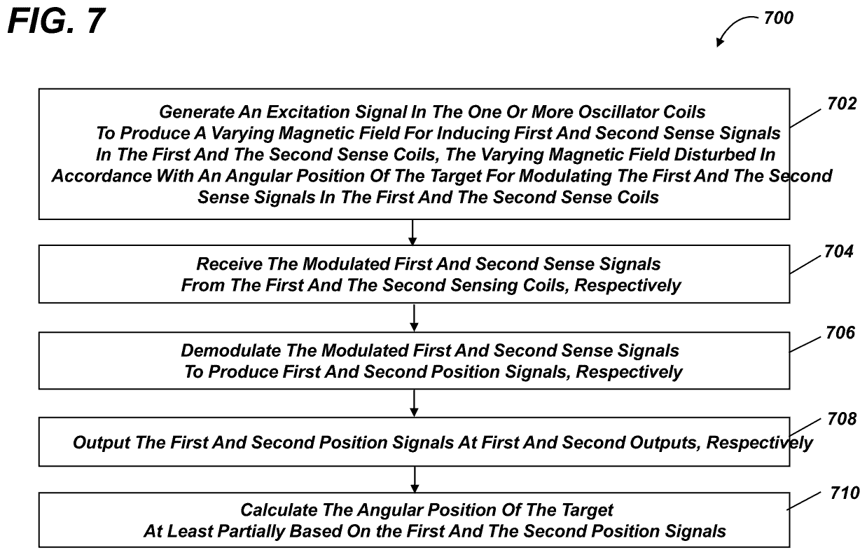

FIG. 7 is a flowchart describing a method 700 of operating an apparatus comprising an inductive angular-position sensor, according to one or more examples. In one or more examples, method 700 may be performed with use of apparatus 100 of FIGS. 1A and 1B.

At acts 702, 704, and 706 of FIG. 7, first and second position signals indicating an angular position of a target may be determined at least partially based on first and second sense signals from the first and second sense coils, respectively. More specifically, at an act 702, an excitation signal in the one or more first oscillator coils is generated to produce a varying magnetic field for inducing the first and second sense signals in the first and second sense coils, respectively. The varying magnetic field may be disturbed in accordance with the angular position of the target for modulating the first and second sense signals. At an act 704, the modulated first and second sense signals are received from the first and second sense coils, respectively. In one or more examples, the modulated first and second sense signals may be modulated first and second sinusoidal signals substantially 90° out of phase with each other. At an act 706, the modulated first and second sense signals are demodulated to produce the first and second position signals, respectively. In one or more examples, the first and second position signals may be first and second voltage position signals and may also be differential signals. At an act 708, the first and second position signals are output at first and second outputs, respectively. At an act 710, the angular position of the target may be calculated at least partially based on the first and second position signals. In one or more examples, the angular position of the target may be calculated at least partially based on an arctan2 function (e.g., by taking an arctan2 function of the ratio of the two sense signals).

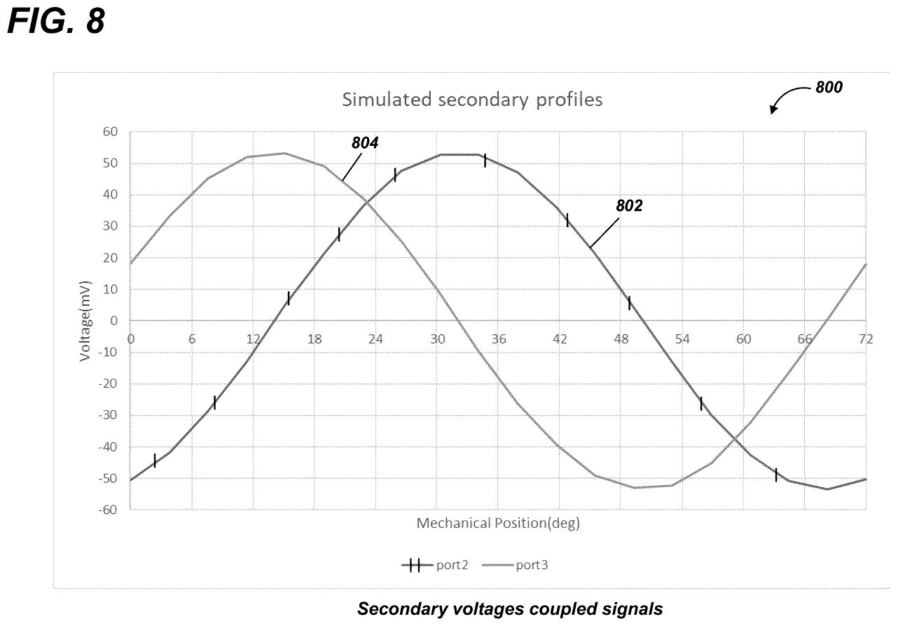

FIG. 8 is a graph 800 of sense signals produced according to a simulation of operation of apparatus 100 comprising the inductive angular-position sensor of FIGS. 1A, 1B, 2A, 2B, 3A-3D, 4A-4D, 5A, and 5B, according to one or more examples. The position sensor circuitry is to generate an excitation signal in the one or more oscillator coils to produce a varying magnetic field for inducing first and second sense signals in the first and the second sense coils. In FIG. 8, a first sense signal 802 (a first sinusoidal signal, such as a cosine wave signal) and a second sense signal 804 (a second sinusoidal signal, such as a sine wave signal) are shown. Here, second sense signal 804 is substantially 90° out of phase with first sense signal 802. In one or more examples, the inductive angular-position sensor is a five (5) pole pair sensor to provide a 72° measurement range with respect to the target (e.g., five (5) cycles for each full or 360° target rotation). In one or more other examples, the coil structure is arranged to accommodate a different measurement range. Note that, when the oscillator's magnetic field is disturbed in accordance with an angular position of the target, first and second sense signals 802 and 804 become modulated first and second sense signals, respectively. The position sensor circuitry is to receive and demodulate the modulated first and second sinusoidal signals to produce first and second position signals, respectively. In one or more examples, the position sensor circuitry (or an MCU or ECU) may calculate the angular position of the target at least partially based on the first and second position signals.

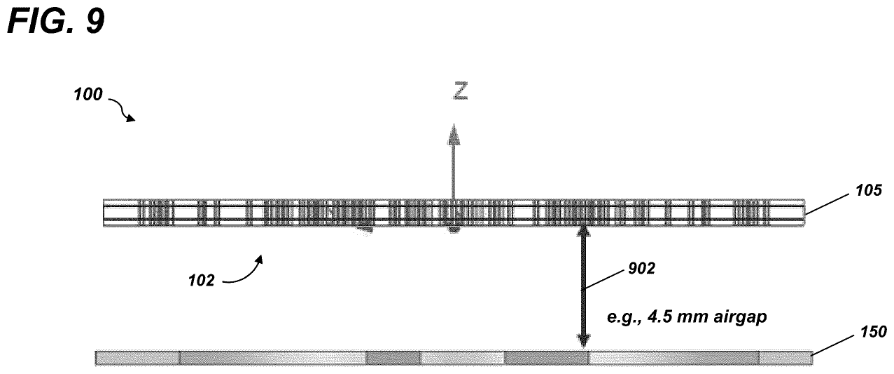

FIG. 9 is a cross-sectional side view of apparatus 100 comprising the inductive angular-position sensor of FIGS. 1A, 1B, 2A, 2B, 3A-3D, 4A-4D, 5A, and 5B, in one or more examples. An airgap 902 between the set of coils 102 on and/or in support structure 105 and target 150 is indicated in the cross-sectional side view of FIG. 9. In one or more examples, airgap 902 may be set to be relatively large as a result of an increased number of coil turns that may be realized according to one or more examples. In the specific, non-limiting example of FIGS. 1A, 1B, 2A, 2B, 3A-3D, 4A-4D, 5A, and 5B, airgap 902 is about 4.5 millimeters (mm).

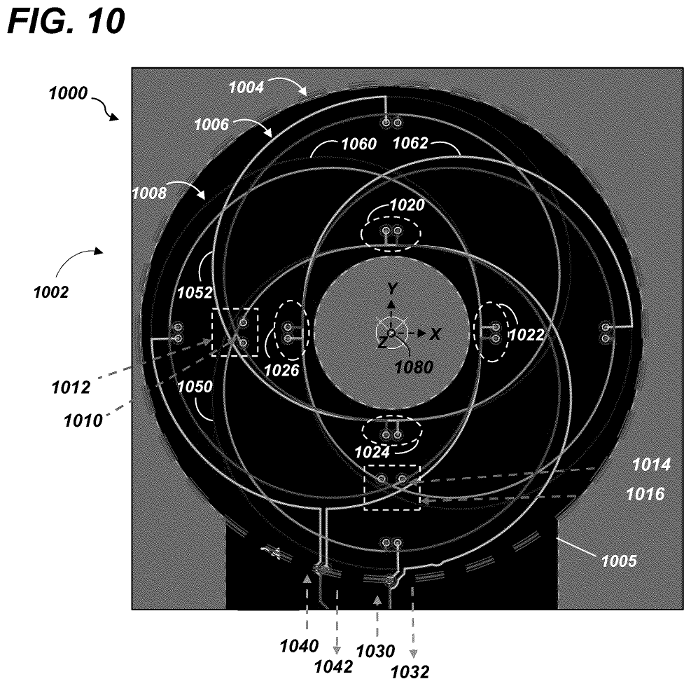

FIG. 10 is a top-down view of an apparatus 1000 comprising an inductive angular-position sensor, according to one or more examples of the disclosure. The inductive angular-position sensor of FIG. 10 is adapted for inductive sensing of an angular position of a target that is rotatable about an axis 1080 (e.g., a central axis of rotation). In FIG. 10, axis 1080 is shown as the Z-axis in a three-dimensional coordinate axis system (X-Y-Z).

In one or more examples, apparatus 1000 comprising the inductive angular-position sensor of FIG. 10 includes similar crossover connection features and turn connection features as apparatus 100 shown and described in relation to at least FIGS. 1A, 1B, 2A, 2B, 3A-3D, 4A-4D, 5A, and 5B. Note that, in FIGS. 10, 11A, 11B, and 12, any black or dark background shading may be removed from the figures.

Apparatus 1000 of FIG. 10 includes a coil structure 1002 for inductive angular-position sensing. Coil structure 1002 includes one or more oscillator coils 1004, a first sense coil 1006, and a second sense coil 1008. One or more oscillator coils 1004 may be referred to as one or more primary coils, and first and second sense coils 1006 and 1008 may be referred to as secondary coils. In one or more examples, one or more oscillator coils 1004 and first and second sense coils 1006 and 1008 are substantially planar coils. In one or more examples, coil structure 102 may be at least partially formed by conductive traces on and/or in one or more layers (e.g., multiple layers or planes) of a support structure 1005. In one or more examples, support structure 1005 may be or include a substrate, such as a PCB.

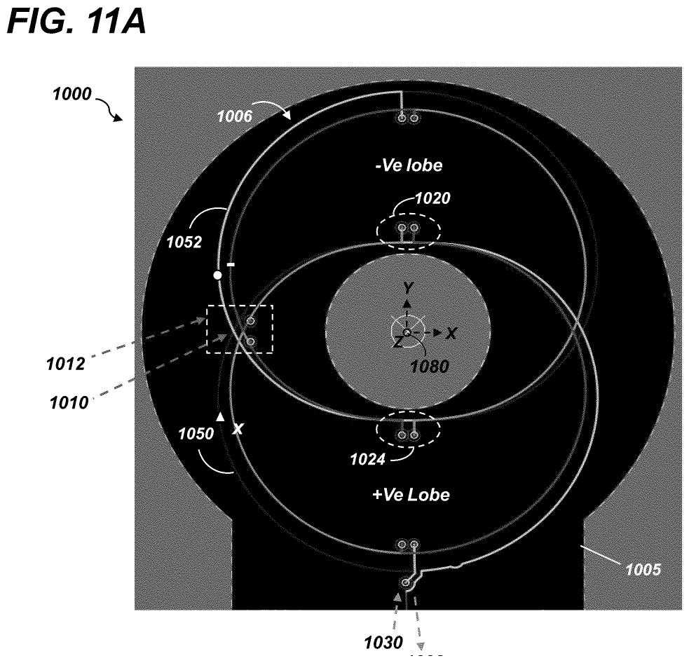

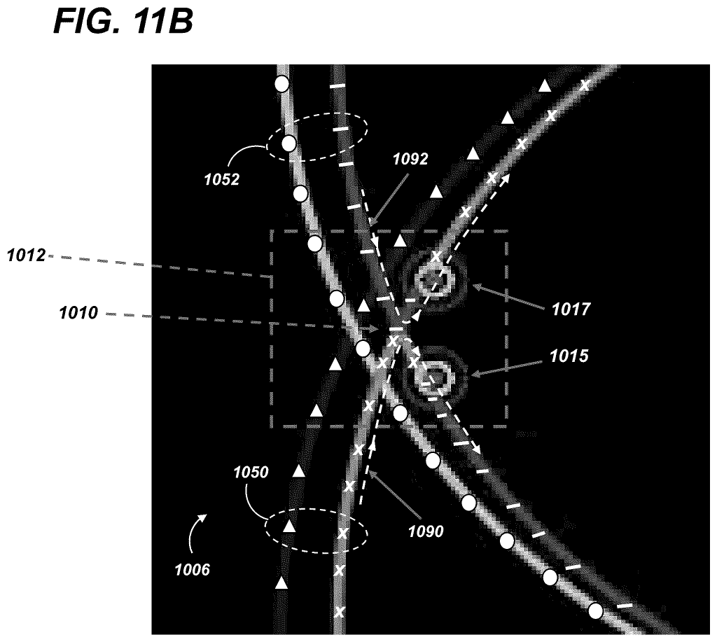

One or more oscillator coils 1004 define an annular-shaped path arranged around axis 1080 for electrical current to flow. First sense coil 1006 includes a first coil portion 1050 and a second coil portion 1052. FIG. 11A is a top-down view of first sense coil 1006 with the other coils removed for illustrative clarity. First coil portion 1050 of first sense coil 1006 defines a first path (e.g., a forward path) for electrical current to flow in a first direction (e.g., a clockwise direction) around axis 1080. First coil portion 1050 of first sense coil 1006 has M turns around axis 1080 defining one in-phase lobe arranged about axis 1080 as shown. In one or more examples, M is an integer number greater than or equal to two (2). In a specific, non-limiting example, M=2. Second coil portion 1052 of first sense coil 1006 defines a second path (e.g., a reverse path) for the electrical current to flow in a second direction (e.g., a counter-clockwise direction) around axis 1080. Second coil portion 1052 of first sense coil 1006 has N turns around axis 1080 defining an out-of-phase lobe arranged about axis 1080. In one or more examples, N is an integer number greater than or equal to two (2). In a specific, non-limiting example, N=2, and/or M=N=2.

In one or more examples, the number of L lobes of respective ones of first and second coil portions 1050 and 1052 of first sense coil 1006 is one (1), and therefore the total number of lobes of first sense coil 106 is two (2) lobes. The in-phase lobe of first coil portion 1050 of first sense coil 1006 is arranged α degrees (mechanically) out of phase with the out-of-phase lobe of second coil portion 1052 of first sense coil 1006. In one or more examples, α=360°/(2×L). In a specific, non-limiting example, α=360/(2×1)=180°.

First coil portion 1050 of first sense coil 1006 includes a turn region 1020 having M turn connections (e.g., two (2) turn connections). In one or more examples, turn region 1020 is located at a bottom of the in-phase lobe of first coil portion 1050. Respective ones of the M turn connections are to connect a respective turn of first coil portion 1050 to a respective next turn of first coil portion 1050 through a respective one of M conductive vias (e.g., two (2) conductive vias). Second coil portion 1052 of first sense coil 1006 includes a turn region 1024 having N turn connections (e.g., two (2) turn connections). In one or more examples, turn region 1024 is located at a bottom of the out-of-phase lobe of second coil portion 1052. Respective ones of the N turn connections are to connect a respective turn of second coil portion 1052 to a respective next turn of second coil portion 1052 through a respective one of N conductive vias (e.g., two (2) conductive vias).

Crossover connections 1010 are provided in an inter-lobe region 1012 of first sense coil 1006 to electrically connect the forward and the reverse paths of the first and the second coil portions 1050 and 1052 of first sense coil 1006. Inter-lobe region 1012 is a region at which the in-phase lobe of first coil portion 1050 meets with the out-of-phase lobe of second coil portion 1052.

In FIG. 10, an entry point 1030 (e.g., a first location) to the first path (e.g., the forward path) of first coil portion 1050 of first sense coil 1006 and an exit point 1032 (e.g., a second location) from the second path (e.g., the reverse path) of second coil portion 1052 of first sense coil 1006 are indicated.

Second sense coil 1008 includes a first coil portion 1060 and a second coil portion 1062. First coil portion 1060 of second sense coil 1008 defines a first path (e.g., a forward path) for electrical current to flow in a first direction (e.g., a clockwise direction) around axis 1080. First coil portion 1060 of second sense coil 1008 has M turns around axis 1080 defining one in-phase lobe arranged about axis 1080 as shown. In one or more examples, M is an integer number greater than or equal to two (2). In a specific, non-limiting example, M=2. First coil portion 1060 of second sense coil 1008 defines a second path (e.g., a reverse path) for the electrical current to flow in a second direction (e.g., a counter-clockwise direction) around axis 1080. Second coil portion 1062 of second sense coil 1008 has N turns around axis 1080 defining one out-of-phase lobe arranged about axis 1080. In one or more examples, N is an integer number greater than or equal to two (2). In a specific, non-limiting example, N=2, and/or M=N=2.

Again, in one or more examples, the number of L lobes of respective ones of first and second coil portions 1060 and 1062 of second sense coil 1008 is one (1), and therefore the total number of lobes of second sense coil 1008 is two (2) lobes. The in-phase lobe of first coil portion 1060 of second sense coil 1008 is arranged α degrees (mechanically) out of phase with the out-of-phase lobe of second coil portion 1062 of second sense coil 1008. In one or more examples, α=360°/(2×L). In a specific, non-limiting example, α=360/(2×1)=180°.

First coil portion 1060 of second sense coil 1008 includes a turn region 1022 having M turn connections (e.g., two (2) turn connections). In one or more examples, turn region 1022 is located at a bottom of the in-phase lobe of first coil portion 1060. Respective ones of the M turn connections are to connect a respective turn of first coil portion 1060 to a respective next turn of first coil portion 1060 through a respective one of M conductive vias (e.g., two (2) conductive vias). In addition, second coil portion 1062 of second sense coil 1008 includes a turn region 1026 having N turn connections (e.g., two (2) turn connections). In one or more examples, turn region 1026 is located at a bottom of the out-of-phase lobe of second coil portion 1062. Respective ones of the N turn connections are to connect a respective turn of second coil portion 1062 to a respective next turn of second coil portion 1062 through a respective one of N conductive vias (e.g., two (2) conductive vias).

Crossover connections 1014 are provided in an inter-lobe region 1016 of second sense coil 1008 to electrically connect the forward and the reverse paths of first and second coil portions 1060 and 1062 of second sense coil 1008. Inter-lobe region 1016 is a region at which the in-phase lobe of first coil portion 1060 meets with the out-of-phase lobe of second coil portion 1062.

In FIG. 10, an entry point 1040 (e.g., a first location) to the first path (e.g., the forward path) of first coil portion 1060 of second sense coil 1008 and an exit point 1042 (e.g., a second location) from the second path (e.g., the reverse path) of second coil portion 1062 of second sense coil 1008 are indicated.

Respective lobes of first sense coil 1006 are arranged Θ degrees out of phase with respective lobes of second sense coil 1008 so as to produce sinusoidal wave signals that are 90° out of phase with each other. In one or more examples, Θ=360°/(2*L). In a specific, non-limiting example, where each sense coil has two (2) lobes, Θ=360°/(2*2)=90°. Note that the target (not shown in FIG. 10) of apparatus 1000 has a target body which is generally planar (i.e., in-plane with the page) and half-circular. More specifically, in one or more examples, the target body has one (1) fin that covers a 180° portion of the target body and one (1) fin aperture between the fin edges (e.g., left and right edges) of the fin that covers a 180° portion of the target body. Accordingly, in one or more examples, apparatus 1000 comprising the inductive angular-position sensor is a one (1) pole pair sensor that provides a 360° measurement range with respect to the target.

FIG. 11B is a close-up view of crossover connections 1010 in inter-lobe region 1012 of first sense coil 1006 from the top-down view of FIG. 11A. In FIG. 11B, a first (inner) turn of first coil portion 1050 is indicated with “x” indicators and a second (outer) turn of first coil portion 1050 is indicated with triangle indicators; a first (inner) turn of second coil portion 1052 is indicated with “-” indicators and a second (outer) turn of second coil portion 1052 is indicated with circle indicators. Also in FIG. 11B, a portion of a first path 1090 (e.g., the forward path) of first coil portion 1050 is indicated by a dashed arrowed line, and a portion of a second path 1092 (e.g., the reverse path) of second coil portion 1052 is indicated by another dashed arrowed line.

Crossover connections 1010 include a first crossover connection 1015 and a second crossover connection 1017 (e.g., a single pair of crossover connections). In general, first and second crossover connections 1015 and 1017 in inter-lobe region 1012 are to electrically connect the forward and the reverse paths of first and second coil portions 1050 and 1052 of first sense coil 1006. In one or more examples, first crossover connection 1015 is to connect an ending portion of an Mth turn of first coil portion 1050 of the in-phase lobe to a starting portion of a first turn of second coil portion 1052 of the out-of-phase lobe. In one or more examples, the number of M turns of first coil portion 1050 are without any other crossover connection to second coil portion 1050 except for first crossover connection 1015 (e.g., the number of M turns defines a substantially continuous conductive path without any other crossover other than first crossover connection 1015). In one or more examples, first crossover connection 1015 connected to a first conductive via defines a first bridge under which, or over which, N−1 turns of second coil portion 1052 are disposed.

In one or more examples, second crossover connection 1017 is to connect an ending portion of an Nth turn of second coil portion 1052 of the out-of-phase lobe to a starting portion of a first turn of first coil portion 1050 of the in-phase lobe. In one or more examples, the number of N turns of second coil portion 1052 are without any other crossover connection to first coil portion 1050 except for second crossover connection 1017 (e.g., the number of N turns defines a substantially continuous conductive path without any other crossover other than second crossover connection 1017). In one or more examples, second crossover connection 1017 connected to a second conductive via defines a first bridge under which, or over which, M−1 turns of first coil portion 1050 are disposed.

An example arrangement of crossover connections 1010 (e.g., first and second crossover connections 1015 and 1017) of first sense coil 1006 has been described in relation to FIG. 11B. Note that, in one or more examples, the arrangement of the crossover connections 1014 (e.g., the first and second crossover connections thereof) in inter-lobe region 1016 of second sense coil 1008 in FIG. 10 is substantially the same as the arrangement of the crossover connections 1010 (e.g., first and second crossover connections 1015 and 1017) of first sense coil 1006 in FIG. 11B.

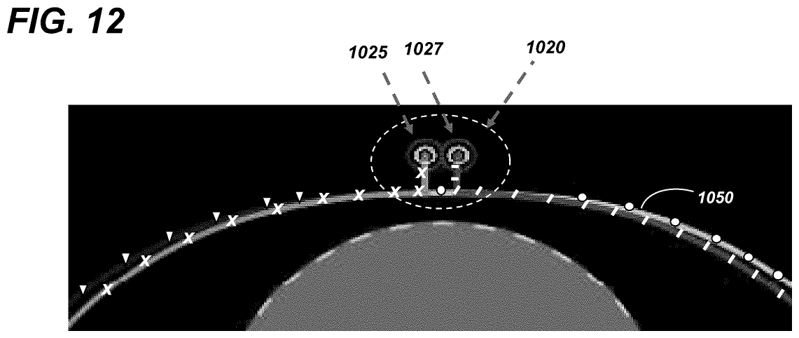

FIG. 12 is a close-up view of turn connections 1025 and 1027 in turn region 1020 of first sense coil 1006 from the top-down view of FIG. 11A. In FIG. 12, the first (inner) turn of first coil portion 1050 is indicated with “x” indicators and the second (outer) turn of first coil portion 1050 is indicated with triangle indicators; the first (inner) turn of second coil portion 1052 is indicated with “-” indicators and the second (outer) turn of second coil portion 1052 is indicated with circle indicators. Respective ones of M turn connections 1025 and 1027 (e.g., two (2) turn connections) are to connect a respective turn of first coil portion 1050 to a respective next turn of first coil portion 1050 through a respective one of M conductive vias (e.g., two (2) conductive vias).

In one or more alternative examples of apparatus 1000 of FIGS. 10, 11A, 11B, and 12, first coil portion 1050 may be associated with the counter-clockwise path and second coil portion 1052 may be associated with the clockwise path, and/or the in-phase lobe first coil portion 1050 may include the out-of-phase lobe and second coil portion 1052 may include the in-phase lobe.

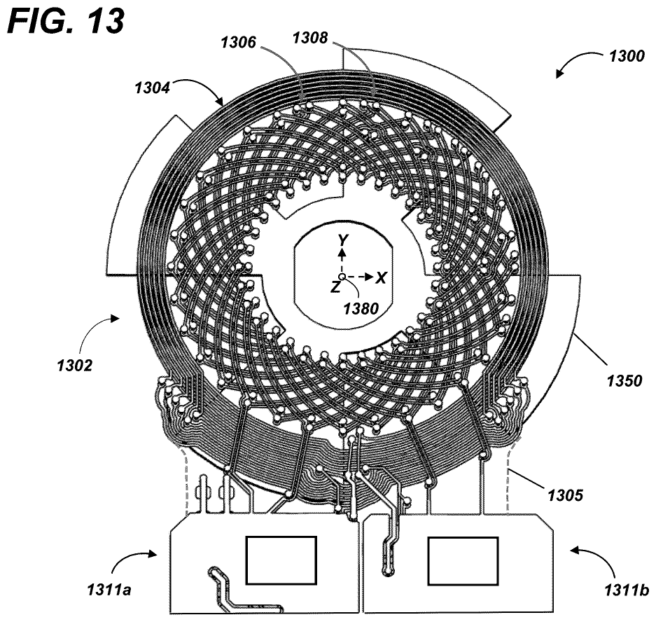

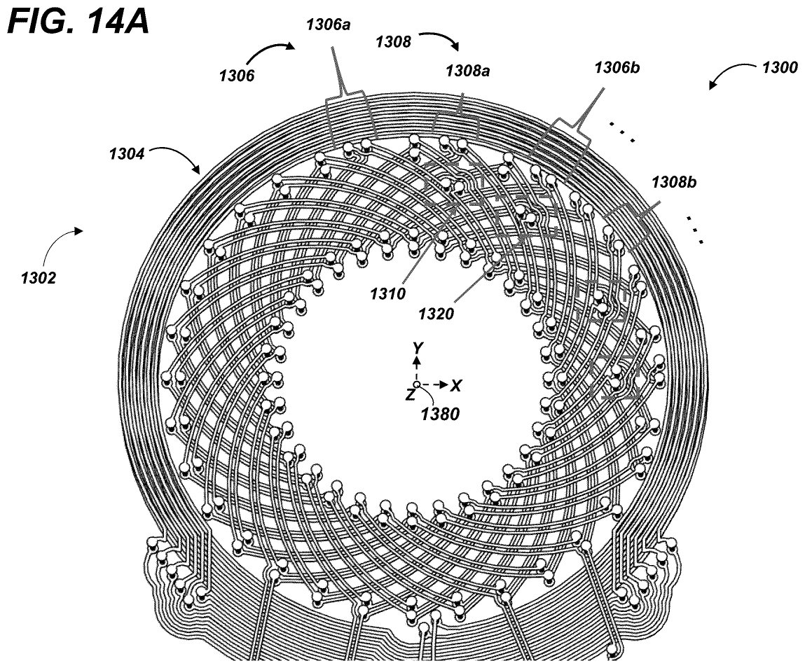

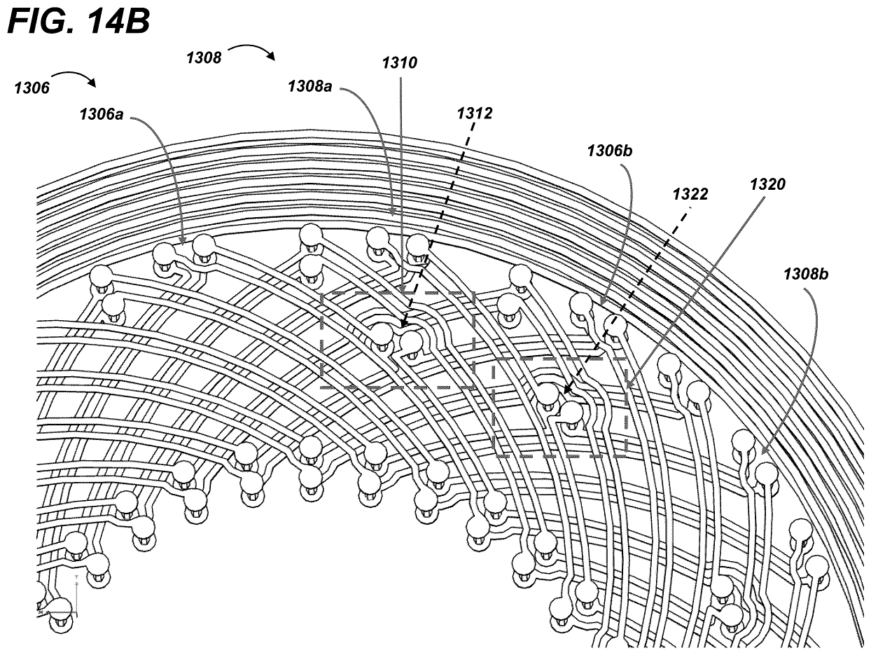

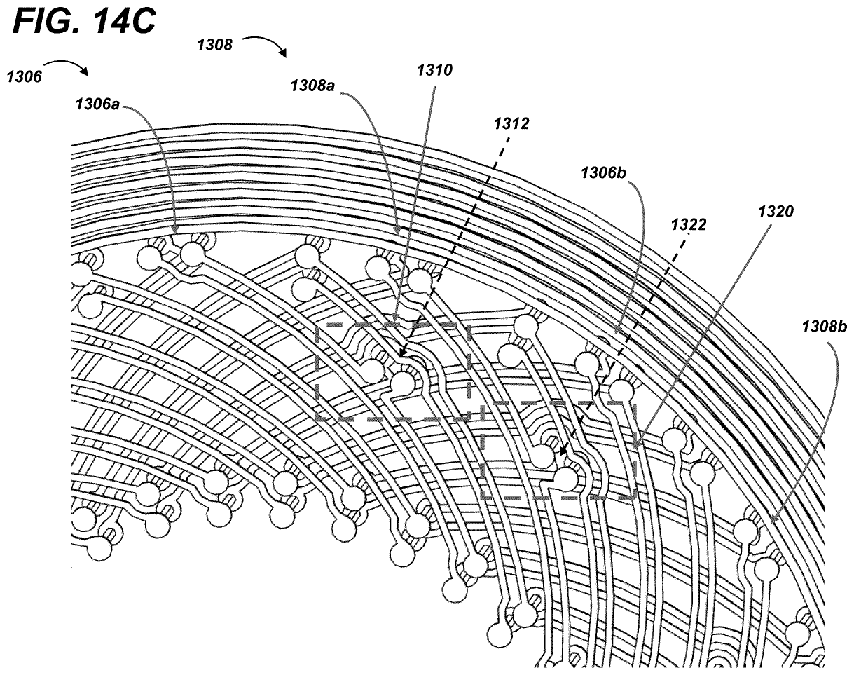

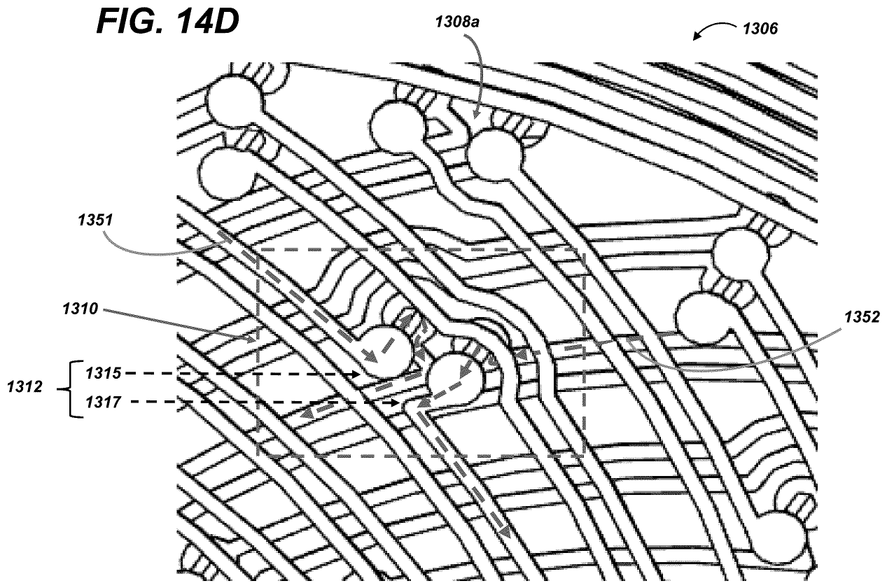

FIGS. 13 and 14A-14D depict an apparatus 1300 comprising at least one inductive angular-position sensor, according to one or more examples of the disclosure. More specifically, in one or more examples, apparatus 1300 of FIGS. 13 and 14A-14D is a redundant inductive angular-position sensing apparatus comprising two or more inductive angular-position sensors, for inductive sensing of an angular position of a target 1350 that rotates around an axis 1380 (e.g., a central axis of rotation).

In a specific, non-limiting example, apparatus 1300 is a redundant inductive angular-position sensing apparatus including a first inductive angular-position sensor and a second inductive angular-position sensor. Here, apparatus 1300 includes at least a first coil structure of a first inductive angular-position sensor and a second coil structure of a second inductive angular-position sensor. In the remaining description of FIGS. 13 and 14A-14D, the focus will be on a coil structure of a first inductive angular-position sensor; however, it should be appreciated that the elements and arrangements of the coil structure of the first inductive angular-position sensor may also apply to the other coil structure of a second inductive angular-position sensor.

With reference to FIG. 13, apparatus 1300 includes a coil structure 1302 for inductive angular-position sensing. Coil structure 1302 includes one or more oscillator coils 1304, a first sense coil 1306, and a second sense coil 1308. One or more oscillator coils 1304 may be referred to as one or more primary coils, and first and second sense coils 1306 and 1308 may be referred to as secondary coils. In one or more examples, one or more oscillator coils 1304 and first and second sense coils 1306 and 1308 are substantially planar coils. In one or more examples, coil structure 1302 may be at least partially formed by conductive traces on and/or in one or more layers (e.g., multiple layers or planes) of a support structure 1305 (a PCB). Apparatus 1300 may include a processing circuitry 1311a for processing of the signals associated with coil structure 1302, as well as an additional processing circuitry 1311b for processing of the signals for redundant sensing.

Target 1350 has a target body which is generally planar (i.e., in-plane with the page) and circular. In one or more examples, target 1350 includes multiple fins that are evenly, radially spaced around axis 1380 (e.g., defining a circular fan shape). In the specific, non-limiting example, the number of fins of the target is four (4). In one or more examples, the (e.g., four) multiple fins of target 1350 are equally, radially spaced about axis 1380, at 90° intervals.

FIG. 14A is a close-up, top-down view of coil structure 1302 of apparatus 1300 of FIG. 13. One or more oscillator coils 1304 define an annular-shaped path arranged around axis 1380 for electrical current to flow. Respective ones of first sense coil 1306 and second sense coil 1308 define a conductive (e.g., continuous) path for electrical current to flow between a first location and a second location. In general, respective ones of first sense coil 1306 and second sense coil 1308 are arranged within an annulus centered around axis 1380.

First sense coil 1306 includes a first coil portion of multiple in-phase lobes (e.g., an in-phase lobe 1306a, and so on) arranged around axis 1380 and a second coil portion of multiple out-of-phase lobes (e.g., an out-of-phase lobe 1306b, and so on) arranged around axis 1380. In general, the first coil portion of first sense coil 1306 defines a first path (e.g., a forward path) for electrical current to flow in a first direction (e.g., a clockwise direction) around axis 1380. More specifically, the first coil portion of first sense coil 1306 having M turns defines a substantially-sinusoidal-wave-shaped path including the multiple in-phase lobes arranged around axis 1380. In one or more examples, M is an integer number greater than or equal to two (2). Respective ones of in-phase lobes (e.g., in-phase lobe 1306a, and so on) have peak and valley portions extending between respective outer and inner circles of the annulus. The second coil portion of first sense coil 1306 defines a second path (e.g., a reverse path) for the electrical current to flow in a second direction (e.g., a counter-clockwise direction) around axis 1380. More specifically, the second coil portion of first sense coil 106 having N turns defines a substantially-sinusoidal-wave-shaped path including the multiple out-of-phase lobes arranged around axis 180. In one or more examples, N is an integer number greater than or equal to two (2). Respective ones of the out-of-phase lobes (e.g., out-of-phase lobe 1306b, and so on) have peak and valley portions extending between the respective outer and inner circles of the annulus. In the specific, non-limiting example shown, M=N=2.

In one or more examples, the number of L lobes of respective ones of the first and the second coil portions of first sense coil 1306 is four (4), and therefore the total number of lobes of first sense coil 1306 is eight (8) lobes. Respective lobes of the first coil portion of first sense coil 1306 are arranged α degrees (mechanically) out of phase with respective lobes of the second coil portion of first sense coil 1306. In one or more examples, α=360°/(2×L). In a specific, non-limiting example, α=360°/(2×4)=45°.

With reference to the close-up views of FIGS. 14B and 14C, crossover connections 1312 are provided in an inter-lobe region 1310 of first sense coil 1306 to electrically connect the forward and the reverse paths of the first and the second coil portions of first sense coil 1306. Inter-lobe region 1310 is a region at which an in-phase lobe (e.g., in-phase lobe 1306a) of the first coil portion meets with an out-of-phase lobe (e.g., out-of-phase lobe 1306b) of the second coil portion.

With reference back to FIG. 14A, second sense coil 1308 includes a first coil portion of multiple in-phase lobes (e.g., an in-phase lobe 1308a, and so on) arranged around axis 1380 and a second coil portion of multiple out-of-phase lobes (e.g., an out-of-phase lobe 1308b, and so on) arranged around axis 1380. The first coil portion of second sense coil 1308 defines a first path (e.g., a forward path) for electrical current to flow in the first direction (e.g., the clockwise direction) around axis 1380. The first coil portion of second sense coil 1308 has M turns around axis 1380 defining multiple in-phase lobes (e.g., in-phase lobe 1308a, and so on) arranged around axis 1380. In one or more examples, M is the integer number greater than or equal to two (2). More specifically, the first coil portion of second sense coil 1308 having M turns defines a substantially-sinusoidal-wave-shaped path including the multiple in-phase lobes. Respective ones of the in-phase lobes (e.g., in-phase lobe 1308a, and so on) have peak and valley portions extending between the respective outer and inner circles of the annulus.

The second coil portion of second sense coil 1308 defines a second path (e.g., a reverse path) for the electrical current to flow in the second direction (e.g., the counter-clockwise direction) around axis 1380. The second coil portion of second sense coil 1308 has N turns around the axis defining multiple out-of-phase lobes (e.g., out-of-phase lobe 1308b, and so on). In one or more examples, N is the integer number greater than or equal to two (2). More specifically, the second coil portion of second sense coil 1308 having N turns defines a substantially-sinusoidal-wave-shaped path including the multiple out-of-phase lobes arranged around axis 1380. Respective ones of out-of-phase lobes (e.g., out-of-phase lobe 1308b, and so on) have peak and valley portions extending between the respective outer and inner circles of the annulus. Again, in the specific, non-limiting example shown, M=N=2.

In one or more examples, the number of L lobes of respective ones of the first and the second coil portions of second sense coil 1308 is four (4), and therefore the total number of lobes of second sense coil 1308 is eight (8) lobes. Respective lobes of the first coil portion of second sense coil 1308 are arranged α degrees (mechanically) out of phase with respective lobes of the second coil portion of second sense coil 1308. In one or more examples, α=360°/(2×L). In a specific, non-limiting example, where each coil portion has four (4) lobes, α=360°/(2×4)=45°.

With reference back to the close-up views of FIGS. 14B and 14C, crossover connections 1322 are provided in an inter-lobe region 1320 of second sense coil 1308 to electrically connect the forward and the reverse paths of the first and the second coil portions of second sense coil 1308. Inter-lobe region 1320 is a region at which an in-phase lobe (e.g., in-phase lobe 1308a) of the first coil portion meets with an out-of-phase lobe (e.g., out-of-phase lobe 1308b) of the second coil portion.

In one or more examples, M turn connections (e.g., two (2) turn connections) are provided in a first turn region located at a peak of one of the in-phase lobes of the first coil portion of first sense coil 1306 (e.g., and second sense coil 1308). Respective ones of the M turn connections are to connect a respective turn of the first coil portion to a respective next turn of the first coil portion through a respective one of M conductive vias (e.g., two (2) conductive vias). Similarly, N turn connections are provided in a second turn region located at a peak of one of the out-of-phase lobes of the second coil portion of first sense coil 1306 (e.g., and second sense coil 1308). Respective ones of the N turn connections are to connect a respective turn of the second coil portion to a respective next turn of the second coil portion through a respective one of N conductive vias (e.g., two (2) conductive vias).

In one or more examples, respective lobes of first sense coil 1306 are arranged Θ degrees out of phase with respective lobes of second sense coil 1308 so as to produce sinusoidal wave signals that are 90° out of phase with each other. In one or more examples, Θ=360°/(2*L). In a specific, non-limiting example, where each sense coil has eight (8) lobes, Θ=360°/(2*8)=22.5°. In one or more examples, the apparatus including the inductive angular-position sensor may be a four (4) pole pair sensor that provides a 90° measurement range with respect to the target.

With reference to a further close-up view of FIGS. 14D, crossover connections 1312 are provided in inter-lobe region 1310 of first sense coil 1306 to electrically connect the forward and the reverse paths of the first and the second coil portions of first sense coil 1306. In addition, a portion of a first path 1351 (e.g., the forward path) of the first coil portion is indicated by a dashed arrowed line, and a portion of a second path 1352 (e.g., the reverse path) of the second coil portion is indicated by another dashed arrowed line.

In one or more examples, crossover connections 1312 include a first crossover connection 1315 and a second crossover connection 1317 (e.g., a single pair of crossover connections). In one or more examples, first crossover connection 1315 is to connect an ending portion of an Mth turn of the first coil portion of the in-phase lobe to a starting portion of a first turn of the second coil portion of the out-of-phase lobe. In one or more examples, the number of M turns of the first coil portion are without any other crossover connection to the second coil portion except for first crossover connection 1315 (e.g., the number of M turns may be a substantially continuous conductive path without any other crossover other than first crossover connection 1315). Second crossover connection 1317 is to connect an ending portion of an Nth turn of the second coil portion of the out-of-phase lobe to a starting portion of a first turn of the first coil portion of the in-phase lobe. In one or more examples, the number of N turns of the second coil portion are without any other crossover connection to the first coil portion except for second crossover connection 1317 (e.g., the number of N turns may be a substantially continuous conductive path without any other crossover other than first crossover connection 1315).

In one or more specific examples, as shown in FIGS. 14C and 14D, first crossover connection 1315 includes a first conductive via having a first end (e.g., at a first layer of the PCB) and a second end (e.g., at a second layer of the PCB). The first end of the first conductive via is disposed substantially directly (e.g., offset slightly) in the path of the in-phase lobe (i.e., in-phase lobe 1306a) (e.g., at the ending portion of the Mth turn). The second end of the first conductive via is disposed outside of and adjacent the path of the out-of-phase lobe (i.e., in-phase lobe 1306b). A first lateral portion of first crossover connection 1315 is to connect the path of the out-of-phase lobe to the second end of the first conductive via (e.g., at the starting portion of the first turn). Second crossover connection 1317 also includes a second conductive via having a first end (e.g., at the first layer of the PCB) and a second end (e.g., at the second layer of the PCB). The first end of the second conductive via is disposed outside of and adjacent the path of the in-phase lobe (i.e., in-phase lobe 1306a). The second end of the second conductive via is disposed substantially directly (e.g., offset slightly) in the path of the out-of-phase lobe (i.e., out-of-phase lobe 1306b) (e.g., at the ending portion of the Nth turn). A second lateral portion of second crossover connection 1317 is to connect the path of the in-phase lobe to the first end of the second conductive via (e.g., at the starting portion of the first turn).

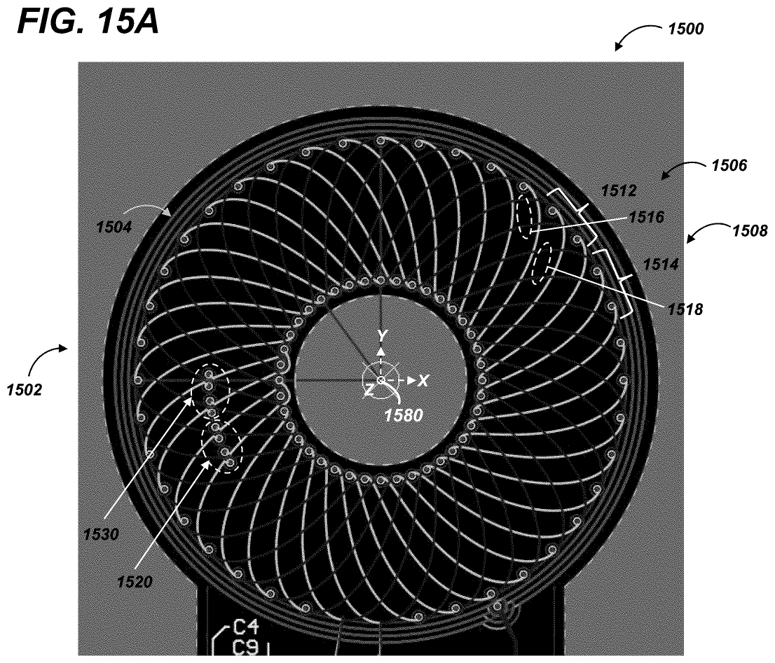

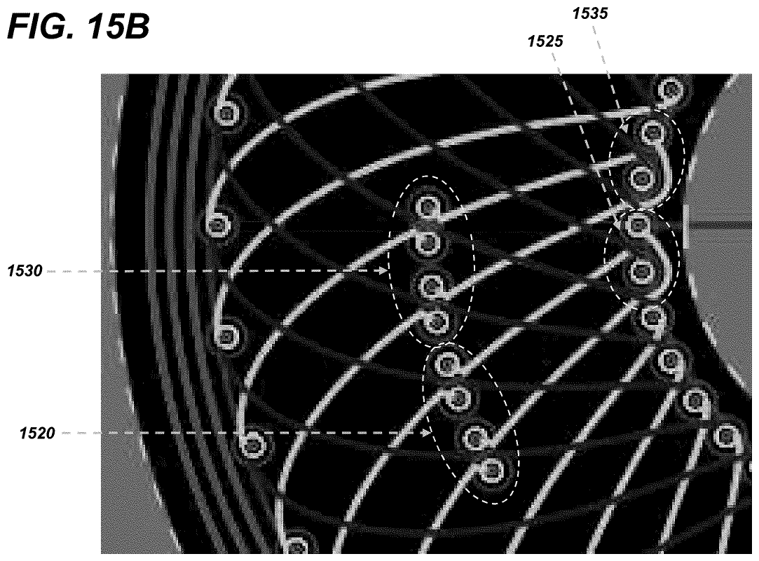

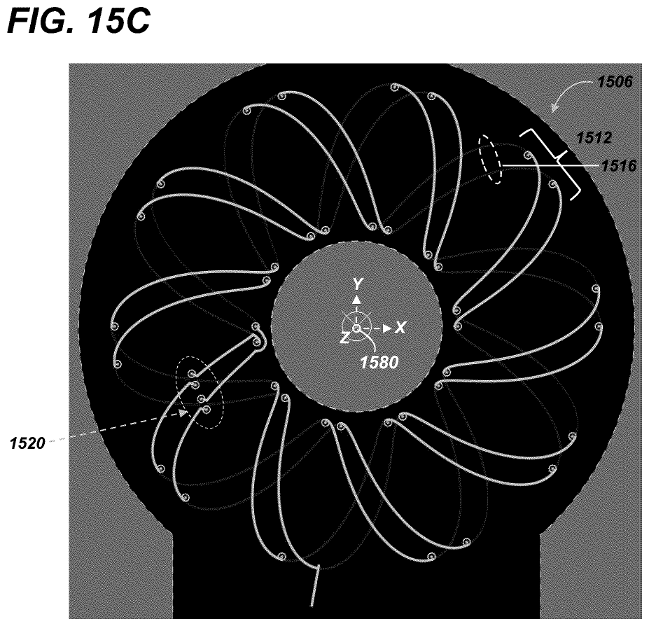

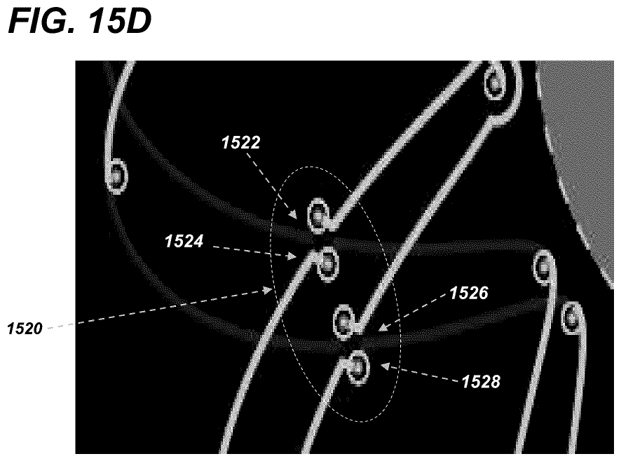

FIG. 15A is a top-down view of an apparatus 1500 comprising a coil structure 1502 of an inductive angular-position sensor that is known by the inventors of this disclosure. Note that, in FIGS. 15A, 15B, 15C, and 15D, any black or dark background shading may be removed from the figures.

In FIG. 15A, coil structure 1502 includes an oscillator coil 1504, a first sense coil 1506, and a second sense coil 1508 arranged around an axis 1580. First sense coil 1506 includes first and second coil portions 1512 associated with two (2) turns 1516 of first sense coil 1506. First sense coil 1506 has crossover points 1520 to connect forward and reverse paths of first and second coil portions 1512 associated with the two (2) turns 1516. Similarly, second sense coil 1508 includes first and second coil portions 1514 associated with two (2) turns 1518 of second sense coil 1508. Second sense coil 1508 has crossover points 1530 to connect forward and reverse paths of first and second coil portions 1514 associated with the two (2) turns 1518.

FIG. 15B is a close-up view of a portion of the coil structure of FIG. 15A to better illustrate crossover points 1520 and 1530. As shown, crossover points 1520 include four (4) total crossover points, and crossover points 1530 include four (4) total crossover points. Also shown in FIG. 15B are turn connections including turn connections 1525 associated with the first and the second coil portions of the first sense coil and turn connections 1535 associated with the first and the second coil portions of the second sense coil.

FIG. 15C is a top-down view of first sense coil 1506 including first and second coil portions 1512 with the other coils removed for illustrative clarity. FIG. 15D is a close-up view of crossover points 1520 that connect forward and reverse paths of the first and the second coils portions associated with the two (2) turns of first sense coil 1506 of FIG. 15C. As indicated in FIG. 15D, crossover points 1520 include crossover points 1522, 1524, 1526, and 1528.

As is apparent from FIGS. 15A-15D, a crossover point is utilized for each turn in the coil structure, increasing the complexity of the design and unnecessarily consuming (e.g., valuable) area of the PCB. Considering substrate manufacturer clearance tolerances, it is quite challenging to add additional turns to the known coil structure. On the other hand, using the same form factor, three (3) turns can be provided in the coil structure of one or more examples of the disclosure (e.g., apparatus 100 of FIGS. 1A, 1B, 2A, 2B, 3A-3D, 4A-4D, 5A, and 5B). In one or more examples, the arrangements including the crossover connections and the turn connections are simple and efficient (e.g., less complex) and/or may conserve PCB area so that the coils may be laid out more efficiently as desired. In one or more examples, a higher airgap between the coil structure and the target may be achieved. In some examples, the apparatus comprising the inductive angular-position sensor may be provided in a 2-layer PCB design.

In one or more other examples, an apparatus may comprise an inductive linear position sensor including a coil structure (e.g., first and second sense coils laid out in a linear fashion) that applies the same or similar concepts, principles, and arrangements described herein.

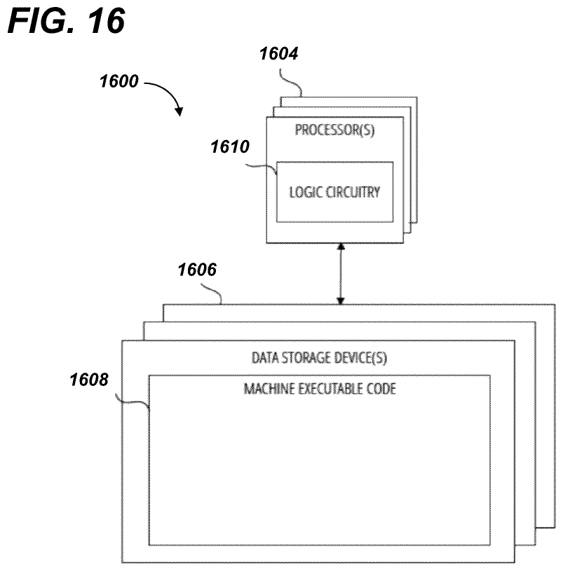

FIG. 16 is a block diagram of circuitry 1600 that, in some examples, may be used to implement various functions, operations, acts, processes, and/or methods disclosed herein. The circuitry 1600 includes one or more processors 1604 (sometimes referred to herein as “processors 1604”) operably coupled to one or more data storage devices (sometimes referred to herein as “storage 1606”). The storage 1606 includes machine-executable code 1608 stored thereon and the processors 1604 include a logic circuit 1610. The machine-executable code 1608 includes information describing functional elements that may be implemented by (e.g., performed by) the logic circuit 1610. The logic circuit 1610 is adapted to implement (e.g., perform) the functional elements described by the machine-executable code 1608. The circuitry 1600, when executing the functional elements described by the machine-executable code 1608, should be considered as special purpose hardware for carrying out functional elements disclosed herein. In some examples, the processors 1604 may perform the functional elements described by the machine-executable code 1608 sequentially, concurrently (e.g., on one or more different hardware platforms), or in one or more parallel process streams.

When implemented by logic circuit 1610 of the processors 1604, the machine-executable code 1608 adapts the processors 1604 to perform operations of examples disclosed herein. For example, the machine-executable code 1608 may be to adapt the processors 1604 to perform at least a portion or a totality of operations associated with the apparatus for inductive angular-position sensing according to one or more examples, including a method of generating an output signal indicative of an angular position of a target; a method of generating a first output signal (e.g., the first sense signal demodulated) based on a first sense signal and a second output signal (e.g., the second sense signal demodulated) based on a second sense signal; and/or a method of generating a single output signal (e.g., a constant-slope output signal) based on the first sense signal and the second sense signal, responsive to rotation of a target.

The processors 1604 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to the machine-executable code 1608 (e.g., software code, firmware code, hardware descriptions) related to examples of the present disclosure. It is noted that a general-purpose processor (may also be referred to herein as a host processor or simply a host) may be a microprocessor, but in the alternative, the processors 1604 may include any conventional processor, controller, microcontroller, or state machine. The processors 1604 may also be implemented as a combination of computing devices, such as a combination of a DSP and a microprocessor, a plurality of microprocessors, one or more microprocessors in conjunction with a DSP core, or any other such configuration.

In some examples, the storage 1606 includes volatile data storage (e.g., random-access memory (RAM)), non-volatile data storage (e.g., Flash memory, a hard disc drive, a solid state drive, erasable programmable read-only memory (EPROM), etc.). In some examples, the processors 1604 and the storage 1606 may be implemented into a single device (e.g., a semiconductor device product, a system on chip (SOC), etc.). In some examples, the processors 1604 and the storage 1606 may be implemented into separate devices.

In some examples, the machine-executable code 1608 may include computer-readable instructions (e.g., software code, firmware code). By way of non-limiting example, the computer-readable instructions may be stored by the storage 1606, accessed directly by the processors 1604, and executed by the processors 1604 using at least the logic circuit 1610. Also by way of non-limiting example, the computer-readable instructions may be stored on the storage 1606, transferred to a memory device (not shown) for execution, and executed by the processors 1604 using at least the logic circuit 1610. Accordingly, in some examples, the logic circuit 1610 includes electrically configurable logic circuit 1610.

In some examples, the machine-executable code 1608 may describe hardware (e.g., circuitry) to be implemented in the logic circuit 1610 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, VERILOG™, SYSTEMVERILOG™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of the logic circuit 1610 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples the machine-executable code 1608 may include an HDL, an RTL, a GL description, a mask level description, other hardware description, or any combination thereof.

In examples where the machine-executable code 1608 includes a hardware description (at any level of abstraction), a system (not shown, but including the storage 1606) may be to implement the hardware description described by the machine-executable code 1608. By way of non-limiting example, the processors 1604 may include a programmable logic device (e.g., an FPGA or a PLC) and the logic circuit 1610 may be electrically controlled to implement circuitry corresponding to the hardware description into the logic circuit 1610. Also by way of non-limiting example, the logic circuit 1610 may include hard-wired logic manufactured by a manufacturing system (not shown, but including the storage 1606) according to the hardware description of the machine-executable code 1608.

Regardless of whether the machine-executable code 1608 includes computer-readable instructions or a hardware description, the logic circuit 1610 is adapted to perform the functional elements described by the machine-executable code 1608 when implementing the functional elements of the machine-executable code 1608. It is noted that although a hardware description may not directly describe functional elements, a hardware description indirectly describes functional elements that the hardware elements described by the hardware description are capable of performing.

As used in the present disclosure, references to things (including excitation coils, sense coils, and paths, without limitation) being “at,” “in,” “on,” “arranged at,” “arranged in,” “arranged on” and like terms a support structure may refer to the things being arranged substantially within and/or on a surface of the support structure.

In addition, the term “substantially” in reference to a given parameter, property, or condition means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, or even at least about 99% met.

Further, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Note that each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.
Example 1: An apparatus comprising: a support structure; and a sense coil comprising conductive traces on, or in, multiple layers of the support structure, the sense coil defining a conductive path for electrical current to flow between a first location and a second location, the sense coil comprising: a first coil portion defining a first path for electrical current to flow in a first direction around an axis of the support structure, the first coil portion having M turns around the axis defining one or more in-phase lobes, where M is an integer number greater than or equal to two; a second coil portion defining a second path for the electrical current to flow in a second direction around the axis, the second direction opposite the first direction, the second coil portion having N turns around the axis defining one or more out-of-phase lobes, where N is an integer number greater than or equal to two; and crossover connections in an inter-lobe region of the sense coil, the inter-lobe region comprising a region at which an in-phase lobe of the first coil portion meets with an out-of-phase lobe of the second coil portion, the crossover connections including: a first crossover connection to connect an ending portion of an Mth turn of the first coil portion of the in-phase lobe to a starting portion of a first turn of the second coil portion of the out-of-phase lobe; and a second crossover connection to connect an ending portion of an Nth turn of the second coil portion of the out-of-phase lobe to a starting portion of a first turn of the first coil portion of the in-phase lobe.
Example 2: The apparatus according to Example 1, wherein the first crossover connection comprises: a first lateral portion at the ending portion on the Mth turn of the first coil portion of the in-phase lobe, the first lateral portion extending laterally from the in-phase lobe in a first lateral direction to connect to a first conductive via; and a second lateral portion at the starting portion on the first turn of the second coil portion of the out-of-phase lobe, the second lateral portion extending laterally from the out-of-phase lobe in the first lateral direction to connect to the first conductive via.
Example 3: The apparatus according to Examples 1 and 2, wherein the first and the second lateral portions connected to the first conductive via define a first bridge under which, or over which, N−1 turns of the second coil portion are disposed.
Example 4: The apparatus according to Examples 1 to 3, wherein the second crossover connection comprises: a third lateral portion at the ending portion on the Nth turn of the second coil portion of the out-of-phase lobe, the third lateral portion extending laterally from the out-of-phase lobe in a second lateral direction to connect to a second conductive via, the second lateral direction opposite the first lateral direction; and a fourth lateral portion at the starting portion on the first turn of the first coil portion of the in-phase lobe, the fourth lateral portion extending laterally from the in-phase lobe in the second lateral direction to connect to the second conductive via; wherein the third and the fourth lateral portions connected to the second conductive via define a second bridge under which, or over which, M−1 turns of the first coil portion are disposed.
Example 5: The apparatus according to Examples 1 to 4, wherein: the first crossover connection includes a first conductive via having a first end and a second end, the first end of the first conductive via disposed substantially directly in the first path of the in-phase lobe, the second end of the first conductive via disposed outside of and adjacent the second path of the out-of-phase lobe, the first crossover connection including a first lateral portion to connect the second path of the out-of-phase lobe to the second end of the first conductive via; and the second crossover connection includes a second conductive via having a first end and a second end, the first end of the second conductive via disposed outside of and adjacent the first path of the in-phase lobe, the second end of the second conductive via disposed substantially directly in the second path of the out-of-phase lobe, the second crossover connection including a second lateral portion to connect the first path of the in-phase lobe to the first end of the second conductive via.
Example 6: The apparatus according to Examples 1 to 5, wherein: respective ones of the first turn and the Mth turn of the first coil portion alternate between first and second layers of the support structure at respective peak and valley portions of the one or more in-phase lobes through respective conductive vias, respective ones of the first turn and the Nth turn of the second coil portion alternate between the first and the second layers of the support structure at respective peak and valley portions of the one or more out-of-phase lobes through respective conductive vias, the first crossover connection is to connect, through the first conductive via, the ending portion on the Mth turn of the first coil portion of the in-phase lobe on the second layer to the starting portion on the first turn of the second coil portion of the out-of-phase lobe on the first layer, and the second crossover connection is to connect, through the second conductive via, the ending portion on the Nth turn of the second coil portion of the out-of-phase lobe on the first layer to the starting portion on the first turn of the first coil portion of the in-phase lobe on the second layer.
Example 7: The apparatus according to Examples 1 to 6, wherein: the M turns of the first coil portion are without any other crossover connection to the second coil portion except the first crossover connection, and the N turns of the second coil portion are without any other crossover connection to the first coil portion except the second crossover connection.
Example 8: The apparatus according to Examples 1 to 7, comprising: M turn connections in a first turn region located in a peak or a valley of one of the one or more in-phase lobes of the first coil portion, respective ones of the M turn connections to connect a respective turn of the first coil portion to a respective next turn of the first coil portion through a respective one of M conductive vias; and N turn connections in a second turn region located in a peak or a valley one of the one or more out-of-phase lobes of the second coil portion, respective ones of the N turn connections to connect a respective turn of the second coil portion to a respective next turn of the second coil portion through a respective one of N conductive vias.
Example 9: The apparatus according to Examples 1 to 8, wherein M=N=2.
Example 10: The apparatus according to Examples 1 to 9, wherein M=N=3.
Example 11: The apparatus according to Examples 1 to 10, wherein: the one or more in-phase lobes of the first coil portion comprise one in-phase lobe, the one or more out-of-phase lobes of the second coil portion comprise one out-of-phase lobe, and the one in-phase lobe is arranged 180° out of phase with the one out-of-phase lobe.
Example 12: The apparatus according to Examples 1 to 11, wherein: the one or more in-phase lobes of the first coil portion comprise five in-phase lobes, the one or more out-of-phase lobes of the second coil portion comprise five out-of-phase lobes, and respective ones of the five in-phase lobes are arranged 36° out of phase with respective adjacent ones of the five out-of-phase lobes.
Example 13: The apparatus according to Examples 1 to 12, wherein: the first direction comprises one of a generally clockwise direction or a generally counterclockwise direction, and the second direction comprises the other one of the generally clockwise direction or the generally counterclockwise direction.
Example 14: The apparatus according to Examples 1 to 13, comprising: one or more oscillator coils having a circular winding pattern around the axis; a first sense coil arranged within an annulus centered around the axis, the first sense coil comprising the sense coil; a second sense coil arranged within the annulus centered around the axis; the one or more in-phase lobes of the first coil portion having peak and valley portions extending between respective outer and inner circles of the annulus; and the one or more out-of-phase lobes of the second coil portion having peak and valley portions extending between respective outer and inner circles of the annulus.
Example 15: The apparatus according to Examples 1 to 14, comprising: a target arranged to rotate about the axis; and a position sensor circuitry to: generate an excitation signal in the one or more oscillator coils to produce a varying magnetic field for inducing a first sense signal and a second sense signal in the first sense coil and the second sense coil, respectively, the varying magnetic field disturbed in accordance with an angular position of the target for modulating the first sense signal and the second sense signal; receive the modulated first sinusoidal signal and the modulated second sinusoidal signal from the first sense coil and the second sense coil, respectively; demodulate the modulated first sinusoidal signal and the modulated second sinusoidal signal to produce a first position signal and a second position signal, respectively; and output the first position signal and the second position signal at a first output and a second output, respectively.
Example 16: An apparatus, comprising: a support structure; and a single pair of crossover connections in an inter-lobe region of a sense coil, the sense coil comprising conductive traces on, or in, multiple layers of the support structure, the sense coil comprising a first coil portion defining a first path for electrical current to flow in a first direction around an axis of the support structure and a second coil portion defining a second path for electrical current to flow in a second direction around the axis, the first coil portion having M turns around the axis defining multiple in-phase lobes and the second coil portion having N turns around the axis defining multiple out-of-phase lobes, where M=N=2 or 3, the inter-lobe region comprising a region at which an in-phase lobe of the first coil portion meets with an out-of-phase lobe of the second coil portion, the single pair of crossover connections including: a first crossover connection to connect an ending portion of an Mth turn of the first coil portion of the in-phase lobe to a starting portion of a first turn of the second coil portion of the out-of-phase lobe; and a second crossover connection to connect an ending portion of an Nth turn of the second coil portion of the out-of-phase lobe to a starting portion of a first turn of the first coil portion of the in-phase lobe.
Example 17: The apparatus according to Example 16, wherein: the M turns of the first coil portion are without any other crossover connection to the second coil portion except the first crossover connection of the single pair of crossover connections, and the N turns of the second coil portion are without any other crossover connection to the first coil portion except the second crossover connection of the single pair of crossover connections.
Example 18: The apparatus according to Examples 16 and 17, wherein the first crossover connection comprises: a first lateral portion at the ending portion on the Mth turn of the first coil portion of the in-phase lobe, the first lateral portion extending laterally from the in-phase lobe in a first lateral direction to connect to a first conductive via; and a second lateral portion at the starting portion on the first turn of the second coil portion of the out-of-phase lobe, the second lateral portion extending laterally from the out-of-phase lobe in the first lateral direction to connect to the first conductive via, wherein the first and the second lateral portions connected to the first conductive via define a first bridge under which, or over which, N−1 turns of the second coil portion are disposed.
Example 19: The apparatus according to Examples 16 to 18, wherein the second crossover connection comprises: a third lateral portion at the ending portion on the Nth turn of the second coil portion of the out-of-phase lobe, the third lateral portion extending laterally from the out-of-phase lobe in a second lateral direction to connect to a second conductive via, the second lateral direction opposite the first lateral direction; and a fourth lateral portion at the starting portion on the first turn of the first coil portion of the in-phase lobe, the fourth lateral portion extending laterally from the in-phase lobe in the second lateral direction to connect to the second conductive via, wherein the third and the fourth lateral portions connected to the second conductive via define a second bridge under which, or over which, M−1 turns of the first coil portion are disposed.
Example 20: An apparatus comprising: a support structure; and a sense coil comprising conductive traces on, or in, multiple layers of the support structure, the sense coil comprising: a first coil portion defining a first path for electrical current to flow in a first direction around an axis of the support structure, the first coil portion having M turns around the axis defining an in-phase lobe, where M is an integer number greater than or equal to two; a second coil portion defining a second path for the electrical current to flow in a second direction around the axis, the second direction opposite the first direction, the second coil portion having N turns around the axis defining an out-of-phase lobe, where N is an integer number greater than or equal to two; and crossover connections including: a first crossover connection to connect an ending portion of an Mth turn of the first coil portion of the in-phase lobe to a starting portion of a first turn of the second coil portion of the out-of-phase lobe; and a second crossover connection to connect an ending portion of an Nth turn of the second coil portion of the out-of-phase lobe to a starting portion of a first turn of the first coil portion of the in-phase lobe.
Example 21: The apparatus according to Example 20, wherein M=N=2 or M=N=3.
Example 22: The apparatus according to Examples 20 and 21, wherein: the M turns of the first coil portion are without any other crossover connection to the second coil portion except the first crossover connection, and the N turns of the second coil portion are without any other crossover connection to the first coil portion except the second crossover connection.

While the present disclosure has been described herein with respect to certain illustrated examples, those of ordinary skill in the art will recognize and appreciate that the present invention is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. An apparatus comprising:
a support structure; and
a sense coil comprising conductive traces on, or in, multiple layers of the support structure, the sense coil defining a conductive path for electrical current to flow between a first location and a second location, the sense coil comprising:
a first coil portion defining a first path for electrical current to flow in a first direction around an axis of the support structure, the first coil portion having M turns around the axis defining one or more in-phase lobes, where M is an integer number greater than or equal to two;
a second coil portion defining a second path for the electrical current to flow in a second direction around the axis, the second direction opposite the first direction, the second coil portion having N turns around the axis defining one or more out-of-phase lobes, where N is an integer number greater than or equal to two; and
crossover connections in an inter-lobe region of the sense coil, the inter-lobe region comprising a region at which an in-phase lobe of the first coil portion meets with an out-of-phase lobe of the second coil portion, the crossover connections including:
a first crossover connection to connect an ending portion of an Mth turn of the first coil portion of the in-phase lobe to a starting portion of a first turn of the second coil portion of the out-of-phase lobe; and
a second crossover connection to connect an ending portion of an Nth turn of the second coil portion of the out-of-phase lobe to a starting portion of a first turn of the first coil portion of the in-phase lobe.

2. The apparatus of claim 1, wherein the first crossover connection comprises:
a first lateral portion at the ending portion on the Mth turn of the first coil portion of the in-phase lobe, the first lateral portion extending laterally from the in-phase lobe in a first lateral direction to connect to a first conductive via; and
a second lateral portion at the starting portion on the first turn of the second coil portion of the out-of-phase lobe, the second lateral portion extending laterally from the out-of-phase lobe in the first lateral direction to connect to the first conductive via.

3. The apparatus of claim 2, wherein the first and the second lateral portions connected to the first conductive via define a first bridge under which, or over which, N−1 turns of the second coil portion are disposed.

4. The apparatus of claim 3, wherein the second crossover connection comprises:
a third lateral portion at the ending portion on the Nth turn of the second coil portion of the out-of-phase lobe, the third lateral portion extending laterally from the out-of-phase lobe in a second lateral direction to connect to a second conductive via, the second lateral direction opposite the first lateral direction; and
a fourth lateral portion at the starting portion on the first turn of the first coil portion of the in-phase lobe, the fourth lateral portion extending laterally from the in-phase lobe in the second lateral direction to connect to the second conductive via,
wherein the third and the fourth lateral portions connected to the second conductive via define a second bridge under which, or over which, M−1 turns of the first coil portion are disposed.

5. The apparatus of claim 1, wherein:
the first crossover connection includes a first conductive via having a first end and a second end, the first end of the first conductive via disposed substantially directly in the first path of the in-phase lobe, the second end of the first conductive via disposed outside of and adjacent the second path of the out-of-phase lobe, the first crossover connection including a first lateral portion to connect the second path of the out-of-phase lobe to the second end of the first conductive via, and
the second crossover connection includes a second conductive via having a first end and a second end, the first end of the second conductive via disposed outside of and adjacent the first path of the in-phase lobe, the second end of the second conductive via disposed substantially directly in the second path of the out-of-phase lobe, the second crossover connection including a second lateral portion to connect the first path of the in-phase lobe to the first end of the second conductive via.

6. The apparatus of claim 4, wherein:
respective ones of the first turn and the Mth turn of the first coil portion alternate between first and second layers of the support structure at respective peak and valley portions of the one or more in-phase lobes through respective conductive vias,
respective ones of the first turn and the Nth turn of the second coil portion alternate between the first and the second layers of the support structure at respective peak and valley portions of the one or more out-of-phase lobes through respective conductive vias,
the first crossover connection is to connect, through the first conductive via, the ending portion on the Mth turn of the first coil portion of the in-phase lobe on the second layer to the starting portion on the first turn of the second coil portion of the out-of-phase lobe on the first layer, and
the second crossover connection is to connect, through the second conductive via, the ending portion on the Nth turn of the second coil portion of the out-of-phase lobe on the first layer to the starting portion on the first turn of the first coil portion of the in-phase lobe on the second layer.

7. The apparatus of claim 1, wherein:
the M turns of the first coil portion are without any other crossover connection to the second coil portion except the first crossover connection, and
the N turns of the second coil portion are without any other crossover connection to the first coil portion except the second crossover connection.

8. The apparatus of claim 1, comprising:
M turn connections in a first turn region located in a peak or a valley of one of the one or more in-phase lobes of the first coil portion, respective ones of the M turn connections to connect a respective turn of the first coil portion to a respective next turn of the first coil portion through a respective one of M conductive vias; and
N turn connections in a second turn region located in a peak or a valley one of the one or more out-of-phase lobes of the second coil portion, respective ones of the N turn connections to connect a respective turn of the second coil portion to a respective next turn of the second coil portion through a respective one of N conductive vias.

9. The apparatus of claim 1, wherein M=N=2.

10. The apparatus of claim 1, wherein M=N=3.

11. The apparatus of claim 1, wherein:
the one or more in-phase lobes of the first coil portion comprise one in-phase lobe, the one or more out-of-phase lobes of the second coil portion comprise one out-of-phase lobe, and
the one in-phase lobe is arranged 180° out of phase with the one out-of-phase lobe.

12. The apparatus of claim 1, wherein:
the one or more in-phase lobes of the first coil portion comprise five in-phase lobes, the one or more out-of-phase lobes of the second coil portion comprise five out-of-phase lobes, and
respective ones of the five in-phase lobes are arranged 36° out of phase with respective adjacent ones of the five out-of-phase lobes.

13. The apparatus of claim 1, wherein:
the first direction comprises one of a generally clockwise direction or a generally counterclockwise direction, and
the second direction comprises the other one of the generally clockwise direction or the generally counterclockwise direction.

14. The apparatus of claim 1, comprising:
one or more oscillator coils having a circular winding pattern around the axis;
a first sense coil arranged within an annulus centered around the axis, the first sense coil comprising the sense coil;
a second sense coil arranged within the annulus centered around the axis;
the one or more in-phase lobes of the first coil portion having peak and valley portions extending between respective outer and inner circles of the annulus; and
the one or more out-of-phase lobes of the second coil portion having peak and valley portions extending between respective outer and inner circles of the annulus.

15. The apparatus of claim 14, comprising:
a target arranged to rotate about the axis; and
a position sensor circuitry to:
generate an excitation signal in the one or more oscillator coils to produce a varying magnetic field for inducing a first sense signal and a second sense signal in the first sense coil and the second sense coil, respectively, the varying magnetic field disturbed in accordance with an angular position of the target for modulating the first sense signal and the second sense signal;
receive the modulated first sense signal and the modulated second sense signal from the first sense coil and the second sense coil, respectively;
demodulate the modulated first sense signal and the modulated second sense signal to produce a first position signal and a second position signal, respectively; and
output the first position signal and the second position signal at a first output and a second output, respectively.

16. An apparatus, comprising:
a support structure; and
a single pair of crossover connections in an inter-lobe region of a sense coil, the sense coil comprising conductive traces on, or in, multiple layers of the support structure, the sense coil comprising a first coil portion defining a first path for electrical current to flow in a first direction around an axis of the support structure and a second coil portion defining a second path for electrical current to flow in a second direction around the axis, the first coil portion having M turns around the axis defining multiple in-phase lobes and the second coil portion having N turns around the axis defining multiple out-of-phase lobes, where M=N=2 or 3, the inter-lobe region comprising a region at which an in-phase lobe of the first coil portion meets with an out-of-phase lobe of the second coil portion, the single pair of crossover connections including:
a first crossover connection to connect an ending portion of an Mth turn of the first coil portion of the in-phase lobe to a starting portion of a first turn of the second coil portion of the out-of-phase lobe; and
a second crossover connection to connect an ending portion of an Nth turn of the second coil portion of the out-of-phase lobe to a starting portion of a first turn of the first coil portion of the in-phase lobe.

17. The apparatus of claim 16, wherein:
the M turns of the first coil portion are without any other crossover connection to the second coil portion except the first crossover connection of the single pair of crossover connections, and
the N turns of the second coil portion are without any other crossover connection to the first coil portion except the second crossover connection of the single pair of crossover connections.

18. The apparatus of claim 16, wherein the first crossover connection comprises:
a first lateral portion at the ending portion on the Mth turn of the first coil portion of the in-phase lobe, the first lateral portion extending laterally from the in-phase lobe in a first lateral direction to connect to a first conductive via; and
a second lateral portion at the starting portion on the first turn of the second coil portion of the out-of-phase lobe, the second lateral portion extending laterally from the out-of-phase lobe in the first lateral direction to connect to the first conductive via,
wherein the first and the second lateral portions connected to the first conductive via define a first bridge under which, or over which, N−1 turns of the second coil portion are disposed.

19. The apparatus of claim 18, wherein the second crossover connection comprises:
a third lateral portion at the ending portion on the Nth turn of the second coil portion of the out-of-phase lobe, the third lateral portion extending laterally from the out-of-phase lobe in a second lateral direction to connect to a second conductive via, the second lateral direction opposite the first lateral direction; and
a fourth lateral portion at the starting portion on the first turn of the first coil portion of the in-phase lobe, the fourth lateral portion extending laterally from the in-phase lobe in the second lateral direction to connect to the second conductive via,
wherein the third and the fourth lateral portions connected to the second conductive via define a second bridge under which, or over which, M−1 turns of the first coil portion are disposed.

20. An apparatus comprising:
a support structure; and
a sense coil comprising conductive traces on, or in, multiple layers of the support structure, the sense coil comprising:
a first coil portion defining a first path for electrical current to flow in a first direction around an axis of the support structure, the first coil portion having M turns around the axis defining an in-phase lobe, where M is an integer number greater than or equal to two;
a second coil portion defining a second path for the electrical current to flow in a second direction around the axis, the second direction opposite the first direction, the second coil portion having N turns around the axis defining an out-of-phase lobe, where N is an integer number greater than or equal to two; and
crossover connections including:
a first crossover connection to connect an ending portion of an Mth turn of the first coil portion of the in-phase lobe to a starting portion of a first turn of the second coil portion of the out-of-phase lobe; and
a second crossover connection to connect an ending portion of an Nth turn of the second coil portion of the out-of-phase lobe to a starting portion of a first turn of the first coil portion of the in-phase lobe.

21. The apparatus of claim 20, wherein M=N=2 or M=N=3.

22. The apparatus of claim 21, wherein:
the M turns of the first coil portion are without any other crossover connection to the second coil portion except the first crossover connection, and
the N turns of the second coil portion are without any other crossover connection to the first coil portion except the second crossover connection.
